(19) United States
(12) Patent Application Publication
(10) Pub. No.: US 2016/0162845 A1
(43) Pub. Date: Jun. 9, 2016

(54) SYSTEMS, DEVICES, AND METHODS OF PROVIDING AND SUBSCRIBING TO CALENDAR INFORMATION

(71) Applicant: Scapegoat, LLC, Chicago, IL (US)

(72) Inventors: Laura Marie Carroll, Chicago, IL (US); Hagen Mueller, Chicago, IL (US)

(21) Appl. No.: 14/963,997

(22) Filed: Dec. 9, 2015

Related U.S. Application Data
(60) Provisional application No. 62/089,640, filed on Dec. 9, 2014.

(51) Int. Cl. G06Q 10/10; G06Q 50/00; G06F 3/0481; G06F 17/30; G06F 3/0484; G06F 3/0482

(52) U.S. Cl. CPC G06Q 10/1095; G06F 3/04847; G06F 3/0482; G06F 3/04817; G06F 17/3053; G06Q 50/01

(57) ABSTRACT

Embodiments of the present disclosure include devices, and methods of providing and subscribing calendar information. Such embodiments include storing, in a memory device by one or more calendar computing devices, a plurality of sets of calendar information from a plurality of calendars, each set of calendar information corresponding to each calendar provided by an associated calendar provider. Further, such embodiments include displaying a user calendar on a user device, by the one or more calendar computing devices, in response to a subscription request, a plurality of subscribed sets of calendar information each set corresponding to a subscribed calendar.

### CROSS-REFERENCE TO RELATED APPLICATIONS

This patent application in a nonprovisional patent application that claims the benefit and priority, under the laws and rules of the United States, to U.S. Provisional Patent Application No. 62/089,640, filed on Dec. 9, 2014. U.S. Provisional Patent Application No. 62/089,640 is incorporated herein by reference in its entirety.

### BACKGROUND

In the current state of the art, there are many calendar software applications (“calendar application”) used by individuals to schedule different events in their daily lives. An individual may use a calendar application on their smartphone or use a calendar application linked to their personal email address to keep track of events associated with their personal life. Alternatively, the individual may keep track of events associated with their professional life using a calendar application linked to their professional email account. Further, the individual may have more than one calendar in a particular calendar application such that one may be for personal events, one for professional events, and one calendar that may combine both personal and professional events.

In addition, the individual may have a need to share aspects of their one or more calendars with others. For example, an individual may share aspects of their personal calendar with family members and friends (e.g., a spouse, children, parents, siblings, classmates, etc.), as well as share aspects of their professional calendar with their colleagues.

However, it is difficult for the individual to provide aspects of their own calendars (personal, professional, social, academic, etc.) or in turn subscribe to view family members', friends' or colleagues calendar information. The disadvantages of the current state of the art is that current calendar applications do not allow a person or entity to make a calendar publicly available to a third party and allow the third party to incorporate the events (or a portion) of the publicly available calendar into the third party's individual calendar. Further, such a third party may not have a personal (e.g., family relation) or professional (e.g., employer-employee) relationship with the person or entity. Current calendar applications do not have any mechanism to incorporate events from one entity's calendar to another's without the entities being related personally or professionally. Accordingly, there is a need for improved systems, devices, and methods of providing and subscribing to calendar information.

Further, students at colleges, universities and other educational institutions, each semester, enroll in courses for their field of study (i.e., major, minor, etc.). Such an enrollment process may be complicated and complex as each major and minor may include course requirements as well as elective courses (i.e., electives) that include prerequisites. Each course is scheduled at certain times and days in a week. Determining a course schedule for a current semester that tries to ensure meeting course requirements in the future can be a complex task. Further, determining a course schedule that takes into account a student's schedule constraints and preferences only adds to the challenge. For example, a student may be involved in a work study program that requires him/her to work from 9-12 noon on Tuesdays and Thursdays but a course requirement may be scheduled at this time. Scheduling around such a work study program is challenging and cumbersome. In addition, a student would like to attend courses with friends and acquaintances so as to organize into study groups. Current calendar applications and course registration application do not allow a student to view the social media connections attending a class prior to enrollment. The problem is further exacerbated due to social media platforms not being integrated into calendar applications. Without such functionality, there is no way for a calendar application, used in enrolling students into courses, to analyze whether any social media connections are concurrently enrolled in a student's courses or analyze course feedback from social media connections. Further, the current state of the art does not allow an instructor of a course to modify a course event (e.g., exam date) and automatically notify as well as enter the modified course event in the personal calendars of enrolled students. Accordingly, there is a need for improved systems, devices, and methods of planning a course schedule based on the course requirements of a field of study as well as based on the student's schedule constraints, preferences, and social media connections.

### SUMMARY

Embodiments of the present disclosure include systems, devices, and methods of providing and subscribing calendar information. Such embodiments include storing, in a memory device by one or more calendar computing devices, a plurality of sets of calendar information from a plurality of calendars, each set of calendar information corresponding to each calendar provided by an associated calendar provider. Further, such embodiments include displaying a user calendar on a user device, by the one or more calendar computing devices, in response to a subscription request, a plurality of subscribed sets of calendar information each set corresponding to a subscribed calendar. In addition, such embodiments include receiving, by the one or more calendar computing devices, the plurality of sets of calendar information corresponding to a plurality of calendar from a plurality of calendar providers. Moreover, such embodiments include a user calendar for a user, by the one or more calendar computing devices, in response to a user generation request from the user device. Also, such embodiments include receiving, by the one or more calendar computing devices, a subscription request from the user device, such that the subscription request includes a calendar identifier corresponding to one of the plurality of calendars, wherein displayed calendar information corresponding to a subscribed calendar is based on the calendar identifier.

Further, such embodiments include displaying, by the one or more calendar computing devices, a set of subscribed calendars on the user device. In addition, such embodiments include providing, by the one or more calendar computing devices, in response to receipt of a sharing request, user calendar information from the user calendar to a plurality of calendar connections. Moreover, such embodiments include that the providing (i.e., provision) of the user calendar information is based on a sharing setting configurable by the user. Also, such embodiments include linking, by the one or more calendar computing devices, the user calendar to a plurality of calendars each corresponding to a calendar connection, such that the linking is in response to a linking request.

Further, such embodiments include determining, by the one or more calendar computing devices, an available calendar date and time for a scheduling event, in response to a scheduling request, based on availability in the user calendar and availability in each of the plurality of calendars, each corresponding to a calendar connection.

The one or more calendar computing devices includes one or more modules that are implemented by one or more processors and are stored, in part, in one or more memory devices that execute functions, actions, steps/aspects of methods, etc. of the one or more calendar computing devices described herein.

Additional embodiments of the present disclosure include systems, devices, and methods of generating a course schedule for a student based on course requirements as well as student schedule constraints, schedule preferences, and social media connections. Such embodiments include receiving, by a calendar server, a schedule request for a plurality of courses from a user computing device for a user schedule. The schedule request includes configuration information. In addition, such embodiments include processing a user profile to determine course requirements for a user as well as determining the plurality of courses based on the schedule request and course requirements. Further, such embodiments include analyzing social media feedback of the plurality of courses from social media user connections. Moreover, such embodiments include weighting the plurality of courses based on configuration information and the social media feedback from user social media connections as well as ranking the plurality of courses based on a weight of each of the plurality of courses. Also, such embodiments include scheduling the plurality of courses for the user schedule based on a rank of each of the plurality of courses as well as presenting the user schedule on a user computing device.

Further, such embodiments include interacting with the user's one or more social media accounts to determine the user social media connections and receiving configuration instructions from the user computing device for the user that allows a module executing on the calendar server to communicate with a social media server. In addition, such embodiments include receiving login credentials from the user computing device for the user's social media account and accessing the user's social media account. Configuration information includes user schedule constraints, user schedule preferences, user configuration input. Rank is based on a plurality of course requirements, a plurality of prerequisite course requirements, and/or a schedule of each of the plurality of course requirements and the plurality of prerequisite course requirements. User schedule constraints include time of day constraints, geographical constraints, instructor constraints, and exam schedule constraints. User schedule preferences include time of day preferences, geographical preferences, instructor preferences, and exam schedule preferences.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system providing and subscribing calendar information in accordance with some embodiments.

FIG. 2 is a block diagram of one or more devices for providing and subscribing calendar information in accordance with some embodiments.

FIGS. 3A-3B are user interfaces for providing and subscribing calendar information in accordance with some embodiments.

FIG. 4 is a flowchart of a method for providing and subscribing calendar information in accordance with some embodiments.

FIG. 5 is a block diagram of one or more devices for providing and subscribing calendar information in accordance with some embodiments.

FIGS. 6A-6C are user interfaces for scheduling calendar information in accordance with some embodiments.

FIG. 7 is a flowchart of a method for scheduling calendar information in accordance with some embodiments.

FIG. 8A-8H are user interfaces for scheduling calendar information by a student in accordance with some embodiments.

FIG. 9A-9F are user interfaces for scheduling calendar information by a professor in accordance with some embodiments.

FIG. 10A-10C are user interfaces for providing organization information on students' calendar by an organization in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein. Also, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as a processor, or processors, with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules.” The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

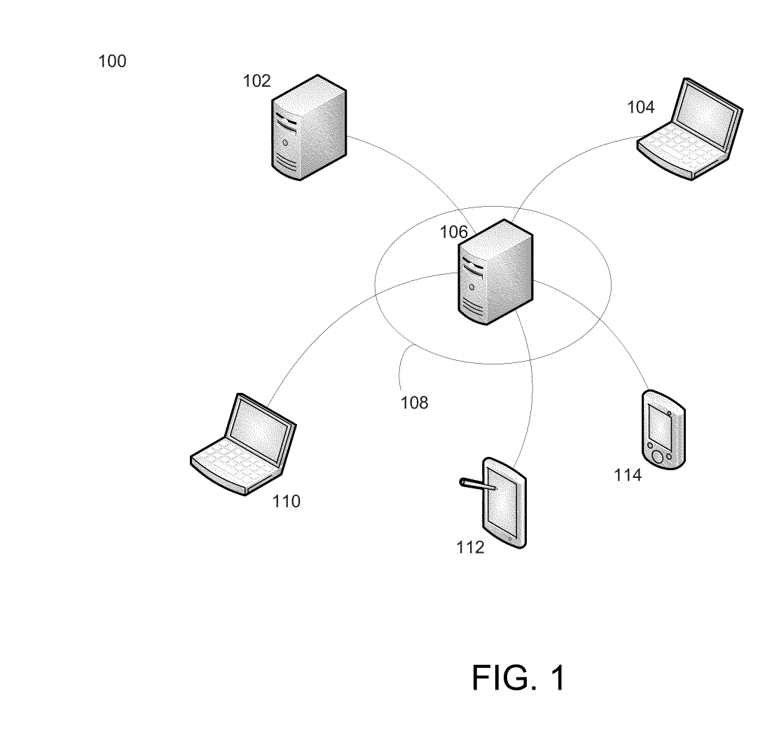

FIG. 1 is a block diagram of a system 100 providing and subscribing calendar information in accordance with some embodiments. The system 100 includes a computer server 102 that may be operated by a calendar provider, such as a university or other educational institution, as well as a computing device 104 that may be operated by another calendar provider, such as a professor or instructor of the educational institution. The computer server 102 and the computing device 104 may be coupled, over a communication network 108, to a calendar cloud computer server 106 operated by a calendar service provider. Further, one or more user devices (110, 112, 114) may be coupled to the calendar cloud computer server 106 over the communication network 108.

The computer server 102, calendar cloud computer server 106, computing device 104, and user devices (110, 112, 114) may be collectively called calendar computing devices as described herein. Further, the computer server 102 and calendar cloud computer server 106 may be any computing device that may provide, implement, or execute computer server functions. The computing device 104 and user devices (110, 112, 114) may be any computing devices including, but not limited to, desktop computers, laptop computers, notebook computers, tablet computers, and smartphones. The communication network 108 may be one network, or a combination of networks, including parts of an Ethernet, WiFi network, wireless network, optical network, cellular network, Internet, Public Switch Telephone Network (PSTN), etc.

Although embodiments shown in FIG. 1 describe a calendar provider to be an educational institution or an instructor, a calendar provider may be a user, person, or any other entity that provides calendar information to the system. Further, calendar information may be any information such as an event title, time, date, location, participants, attendees or any other information associated with a calendar.

The system 100 allows users associated with user devices (110, 112, 114) to subscribe to calendar information provided by a plurality of calendar providers. In one embodiment, a university may provide course calendars for various courses to the calendar cloud computer server 106 from a computer server 102. In another embodiment, a professor may update a certain event on the course calendar provided by the university from computing device 104. For example, the university may provide a course calendar for a course, Chemistry 101, which includes an event such as a final exam scheduled for December 10. Further, the professor for Chemistry 101 may update the final exam event from being scheduled on December 10 to December 11. Generally, the calendar cloud computer 106 server may store, in a memory device, a plurality of sets of calendar information from a plurality of calendars, each set of calendar information corresponding to a calendar provided by an associated calendar provider.

A calendar software application (“calendar application”), or an embodiment thereof, may be downloaded onto a user computing device (110, 112, 114) by a student. Such a calendar application includes a user interface and may interact with a calendar cloud computer server 106 as described herein. Further, the calendar application or an embodiment thereof may also be downloaded to a professor's computing device 104 such that the professor may provide course calendar information as described herein.

A user may subscribe to the one or more calendars stored in the calendar cloud computer server. The user may be a student and is associated with the user device 110 that has a calendar application stored and executed on the user device 110 configured to communicate with the calendar cloud computer server 106. Further, the user may be a student of a course, Chemistry 101, and may send a request to the calendar cloud computer device 106 to subscribe to the Chemistry 101 course calendar. In addition, the student may subscribe (i.e., send a subscription request) to a calendar for each and every course the student is enrolled according to his/her semester course schedule. In response, the calendar cloud computer server 106 may display (in conjunction with the calendar application residing on the user device 110) a user calendar on the user device having a plurality of subscribed sets of calendar information each set corresponding to a subscribed calendar (e.g., subscribed course calendars). Such a user calendar may also be called a master calendar.

In further embodiments, when a calendar provider (e.g., professor) changes an event on a calendar subscribed by the user, the user calendar may be automatically updated with the changed event. Also, in some embodiments, the calendar cloud computer server 106 may send a notification to the calendar application (e.g., alert, text message, notification on a tablet computer or smartphone) residing the user device 110 indicating that an event has been changed on a subscribed calendar. For example, when university professor changes the final exam date from December 10 to December 11 for the Chemistry 101 course (and the user has subscribed to the Chemistry 101 course calendar) the user calendar is automatically updated with the change. Further, the calendar cloud computer server 106 may send a notification to the user device 110 indicating a change in the Chemistry 101 final exam event.

In other embodiments, the user may generate his/her user calendar (i.e., master calendar) prior to subscribing to other entities' calendars. This may include entering/authoring calendar information such as events into the calendar (e.g., “Going Home for Thanksgiving”). Further, embodiments may include a social media aspect of the calendar application such that the user may like to connect, through the calendar application, to other users to create a calendar connection between him/her and another user. Such a calendar connection is analogous to a connections made in other social media platforms (e.g., “Friends” in Facebook, Professional “Connections” in LinkedIn, etc.). In some embodiments, the calendar connections may be already established social media connections (e.g., “Friends” in Facebook, “Connections” in LinkedIn, etc.). In such embodiments, a user may share aspects of his/her user calendar to one or more of his/her calendar connections. Alternatively, the user may subscribe to the calendars of other users who are his/her calendar connections. Thus, the calendar application implemented by the calendar service provider (through the calendar cloud computer server 106 and/or the calendar application running on the user device 110) links the user calendar to a plurality of calendars, each corresponding to a calendar connection and the linking is in response to a linking request. A linking request may be a sharing request or a subscription request as described herein. Thus, the events on a subscribed calendar are incorporated into a user's calendar.

Moreover, the calendar application implemented by the calendar service provider (through the calendar cloud computer server 106 and/or the calendar application running on the user device 110) may determine an available calendar date and time for a scheduling event, in response to a scheduling request, based on availability in the user calendar and availability in each of the plurality of calendars, each corresponding to a calendar connection, thereby automating aspects of scheduling an event among the user and a plurality of his/her calendar connections.

Thus, embodiments of the present disclosure directed to providing and subscribing to calendar information are an advantage of the current state of the art because it allows a person or an entity (university, professor, business, etc.) to make its calendar publicly available to a third party (e.g., student). This allows the third party (e.g., student) to incorporate the person's or entity's calendar (or portion thereof) into its own personal calendar even through the third party has not personal (family) or professional (employer/employee) relationship with the person or entity. Further, embodiments of the present disclosure provides or integrates social media connections into a calendar application allowing a user to subscribe to the calendar (or portion thereof) of one or more social media connections. Such functionality is another advantage over the current state of the art.

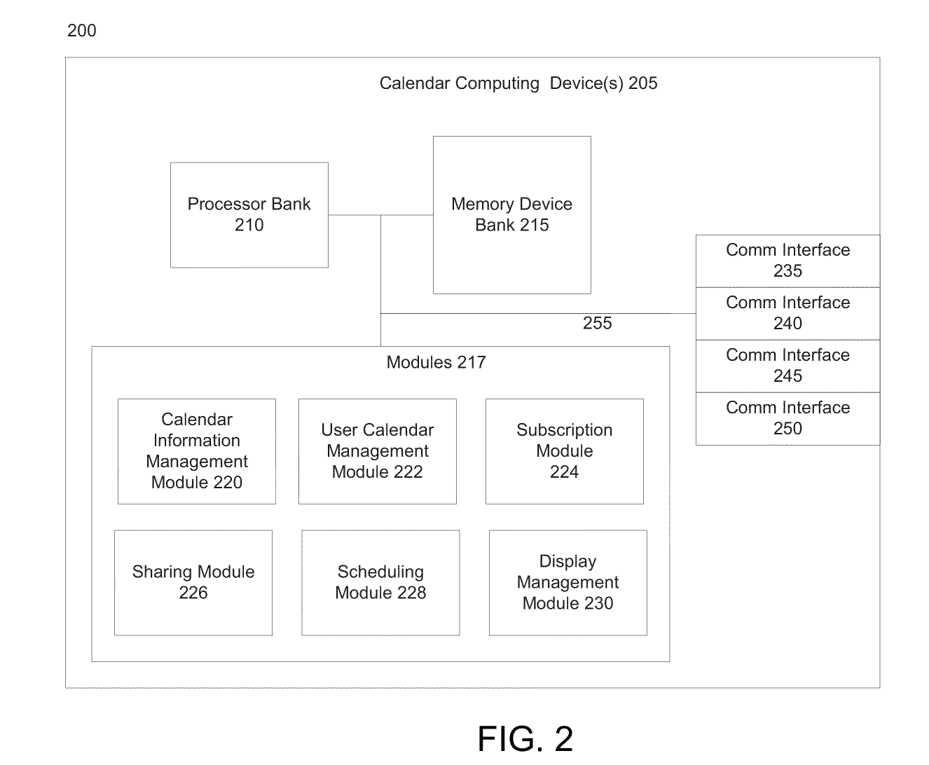

FIG. 2 is a block diagram of one or more devices for providing and subscribing calendar information in accordance with some embodiments. Such calendar computing device(s) 205 may include all or some of the computer server 102, computing device 104, calendar cloud computer server 106, and user devices (110, 112, 114) in the system 100 shown in FIG. 1. Further, the modules 217 may be located in all or spread among the different calendar computing devices in different embodiments. Therefore, the specifically-configured modules 217 are specialized equipment that performs specialized functions. Further, the specifically-configured modules 217 transform the calendar computing device 205 from a generic computing device that only performs generic functions to a specialized calendar computing devices that performs, inter alia, specialized calendar functions as described herein.

In addition, the calendar computing device(s) 205 may include several different components such as a processor bank 210, memory device bank 215, and one or more software applications, which may be executed by a processor. Thus, the combination of the software applications, as well as the processor and any other hardware, form specifically-configured modules 217 as described herein. The calendar computing device(s) 205 also has/have one or more communication interfaces (235-250). The processor bank 210 may include one or more processors that may be co-located with each other or may be located in one module or in different parts of a calendar computing device 205, or among a plurality of calendar computing devices 205. The memory device bank 215 may include one or more storage devices that may be co-located with each other or may be located in one module, in different parts of a calendar computing device or among a plurality of calendar computing device. Types of memory devices may include, but are not limited to, electronic memory, optical memory, and removable storage media. The one or more modules 217 may include a calendar information management module 220, a user calendar management module 222, subscription module 224, a sharing module 226, a scheduling module 228, and a display management module 230. The modules 217 may be implemented by the one or more processors in the processor bank 210. A person of ordinary skill in the art would understand that the calendar application may be implemented by one or more modules described herein as well any other additional modules such that a person of ordinary sill in the art may call some embodiments of the calendar application a “calendar application platform.” Further, the modules and functions thereof may be combined or separated. In addition, such modules can be separated and portions thereof may be implemented across many devices or combined into one device.

The calendar information management module 220 may receive a plurality of sets of calendar information each corresponding to a calendar from one of the plurality of calendar providers (e.g., educational institution, instructor, etc.). Further, the calendar information management module 220 may store in one or more memory devices the plurality of sets of calendar information. Such calendar information may be stored in a database as a database data structure. Further, the calendar information management module may access such calendar information through an Application Programming Interface from an educational institution computer server 102 that is in one type of data structure and must convert or transform such calendar information into a database structure when storing in the database. Alternatively, a subset of the calendar information may be provided by a professor as past of course information from a professor's user computing device running an embodiment of the calendar application. The calendar application may provide on the professor's computing device a user interface that includes a course information template or a course calendar template as well as drop down menus, dialog boxes, links, click button, push buttons, or any other user input receiving mechanisms. Thus, the calendar application receives the course calendar information in a type of user interface data structure and is provided to the calendar information management module 220. Upon storing such calendar information into the database, the calendar information management module 220 may convert or transform the calendar information from a user interface data structure into a database data structure.

The subscription module 224 may receive a subscription request from the user device, such that the subscription request includes a calendar identifier corresponding one of the plurality of calendars. Calendar information to be displayed on a user calendar corresponding to a subscribed calendar is based on the calendar identifier. A calendar identifier may be a title or name of a calendar (e.g., Chemistry 101 Course Schedule, Joe's calendar, etc.) or an alphanumeric code generated and designated to a calendar by one or more modules 217. Upon processing the subscription request, the user's calendar incorporates the events in subscribed calendar based on the calendar identifier.

The sharing module 226 may provide, in response to receipt of a sharing request, user calendar information from the user calendar to a plurality of calendar connections. Such a calendar connection is analogous to connections made in other social media applications (e.g., “Friends” in Facebook, Professional “Connections” in LinkedIn, etc.). In such embodiments, a user may share aspects of his/her user calendar to one or more of his/her calendar connections. Providing the user calendar information is based on a sharing setting configurable by the user. A sharing setting may also be called a privacy setting in some embodiments.

Alternatively, the user may subscribe to the calendars of other users who are his/her calendar connections as well as other entities having calendars that are configured to be publicly available. Thus, the calendar application (through the calendar cloud computer server and/or the calendar application running on the user device 110) links the user calendar to a plurality of calendars, each corresponding to a calendar connection, in response to a linking request. A linking request may be a sharing request or a subscription request as described herein.

The scheduling module 228 may determine an available calendar date and time for a scheduling event, in response to a scheduling request, based on availability in the user calendar and availability in each of the plurality of calendars, each corresponding to a calendar connection. Upon finding availability, the scheduling module may schedule the event on the user calendar and each of the plurality of calendars as well as send a notification of the scheduled event to the user and each calendar connection.

The user calendar management module 222 may generate a user calendar for the user, in response to a user generation request from the user device. The user calendar may include the user's personal calendar as well as subscribed calendars and linked calendars of calendar connections as described herein. However, in some embodiments, the user calendar management module 222 may need to access the calendar information to be presented on the user calendar from a database. In such embodiments, the user calendar management module 222 may convert or transform the calendar information from a database data structure to a calendar data structure. Thus, a portion of the calendar information may have been converted from a user interface data structure into a database data structure and then from a data base data structure into a calendar data structure.

The display management module 230 may display the user calendar, including user calendar information, on the user device. Further, the display management module 230 may display, in response to a subscription request, a plurality of subscribed sets of calendar information, on a user calendar on a user computing device. In addition, the display management module 230 may display a set of subscribed calendars on the user device. In some embodiments, the display may group the names of the subscribed calendars under heading such as “Subscribed” or “Following.”

Each of the communication interfaces (235-250) may be software or hardware associated in communicating to other devices. The communication interfaces (235-250) may be of different types that include a user interface, USB, Ethernet, WiFi, wireless, optical, cellular, or any other communication interface coupled to a communication network.

An intra-device communication link 255 between the processor bank 210, memory device bank 215, modules 217, antennas 260 and communication interfaces (235-350) may be one of several types that include a bus or other communication mechanism.

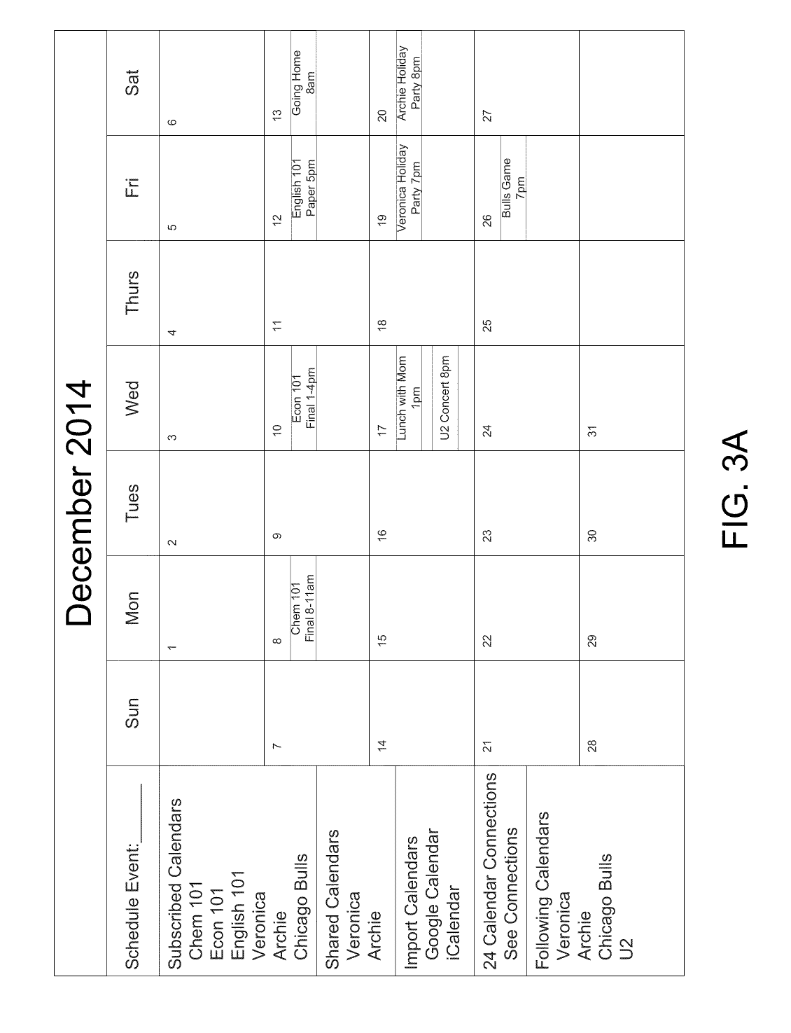

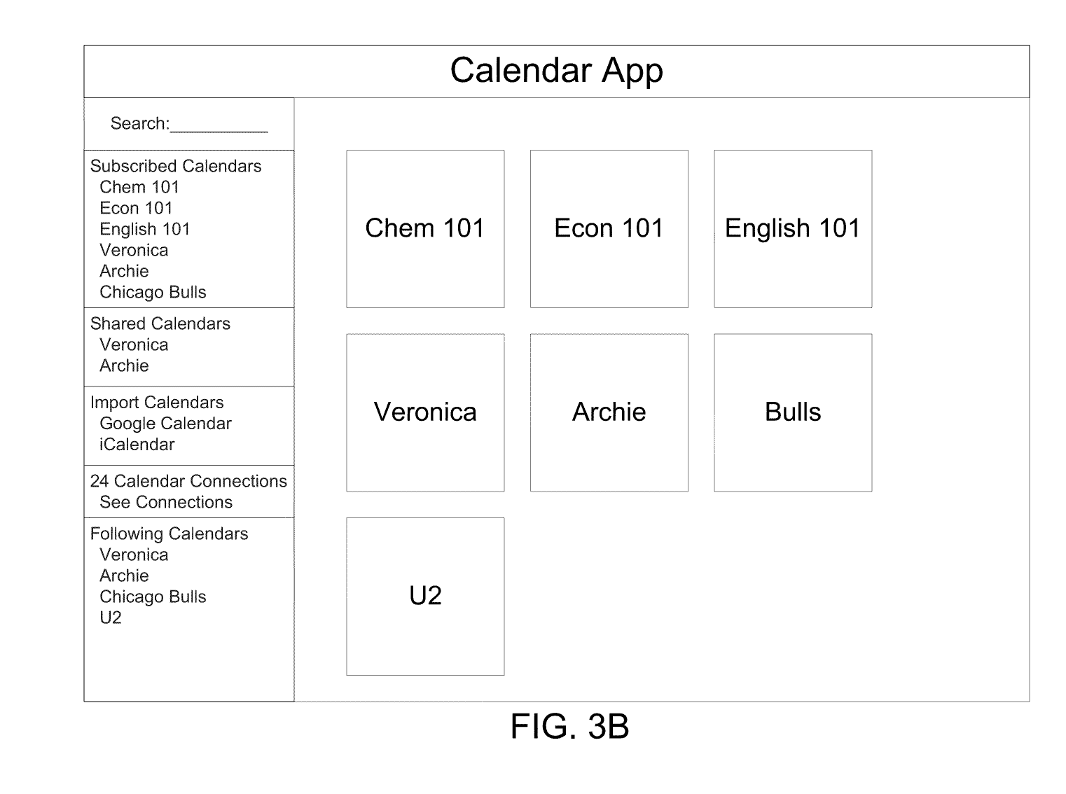

FIGS. 3A-3B are user interfaces for providing and subscribing calendar information in accordance with some embodiments. Such user interfaces may be part of a calendar application the user interface of which is displayed on a smartphone or tablet computer as a mobile application or on a desktop computer, laptop computer, or notebook computer as part of a web application.

Referring to FIG. 3A, a user calendar is shown for December 2014. This user calendar includes user entered/authored events (e.g., “Going Home,” “Lunch with Mom”) as well as events from subscribed calendars that include final exams for enrolled courses, sporting events (Bulls game) and calendar connections' events such as holiday parties (Veronica Holiday Party, Archie Holiday Party).

In addition, the user interface lists the user's subscribed calendars. Each listed subscribed calendar may be a link (e.g., hyperlink—when clicked using a mouse or touchscreen) to the subscribed entity's calendar. Further, the user interface shows the calendar connection to whom the user shared his/her calendar (e.g., Shared Calendars—Veronica, Archie). In addition, the user interface may allow the user to import calendar information from other calendar applications. Moreover, the user interface may list the number of calendar connections for the user and a link (e.g., hyperlink—when clicked using a mouse or touchscreen) to a list of the calendar connections. Also, the user interface lists the entities whose calendars the user is following. The user interface may also allow the user to schedule an event using a link (hyperlink) or dialogue box for himself/herself or among himself/herself and his/her calendar connections. In addition, the user interface may provide one or more views of the user calendar (e.g., master calendar). For example, the user may be able to display/view only the user entered/authored events on the calendar. In another example, the user may be able display/view user authored events as well as a subset of calendar connections' events.

Referring to FIG. 3B, the user interface may list the subscribed and/or followed calendars in an iconic format. Each icon may be a link (e.g., hyperlink—when clicked using a mouse or touchscreen) to view the calendar of the subscribed or followed entity. Further, the user interface may allow the user to search for other calendars associated with other calendar providers.

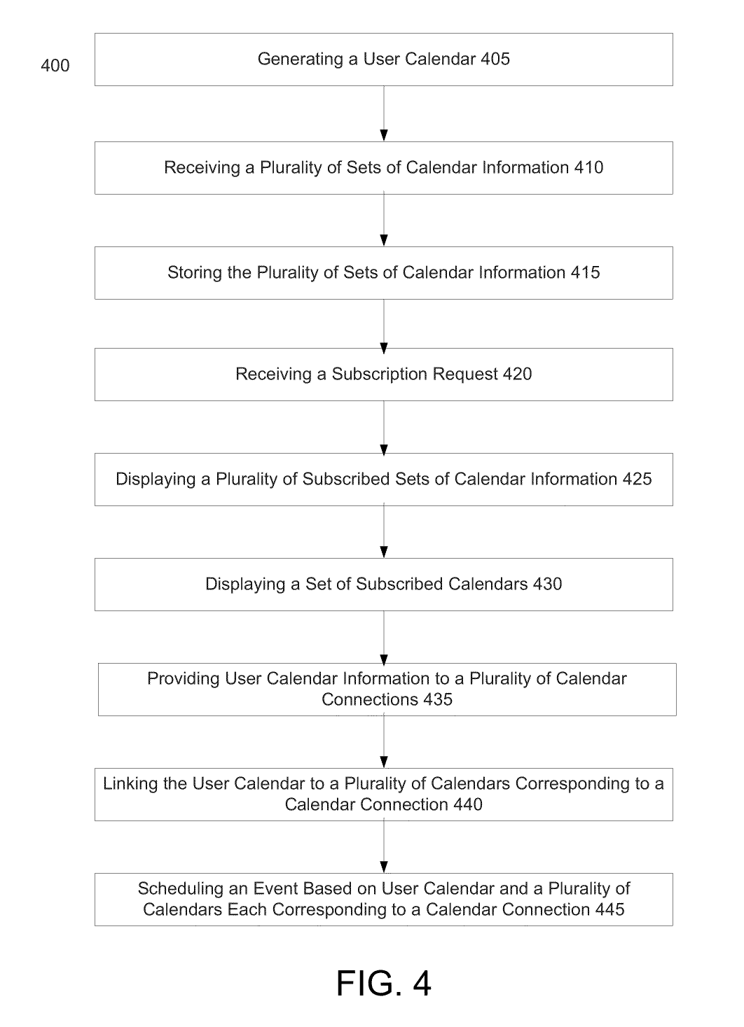

FIG. 4 is a flowchart of a method 400 for providing and subscribing calendar information in accordance with some embodiments. The method 400 includes generating a user calendar for a user in response to a user generation request from the user device, as shown in block 405. The method 400 further includes receiving a plurality of sets of calendar information each corresponding to a calendar from a calendar provider, as shown in block 410. In addition, the method 400 includes storing the plurality of sets of calendar information, as shown in block 415. Moreover, the method 400 includes receiving a subscription request from the user device, as shown in block 420. The subscription request includes a calendar identifier corresponding to one of a plurality of calendars. The calendar application accesses the calendar information based on the calendar identifier and designates such a calendar information as subscribed calendar information that can be incorporated or displayed on a user's calendar. Also, the method 400 includes displaying the user calendar on a user device that includes a plurality of subscribed sets of calendar information each set corresponding to a subscribed calendar, as shown in block 425. Further, the method 400 includes displaying a set of subscribed calendars on the user device, as shown in block 430. In some embodiments, the display may group the names of the subscribed calendars under heading such as “Subscribed” or “Following.”

In addition, the method 400 includes providing, in response to receipt of a sharing request, user calendar information from the user calendar to a plurality of calendar connections, as shown in block 435. Providing the user calendar information is based on a sharing setting configurable by the user. Such a calendar connection is analogous to a connection made in other social media applications (e.g., “Friends” in Facebook, Professional “Connections” in LinkedIn, etc.). In such embodiments, a user may share aspects of his/her user calendar to one or more of his/her calendar connections. Alternatively, the user may subscribe to the calendars of other users who are his/her calendar connections as well as other entities that configure their calendars to be publicly available. Moreover, the method 400 includes linking the user calendar to a plurality of calendars each corresponding to a calendar connection in response to a linking request, as shown in block 440. A linking request may be a sharing request or a subscription request as described herein. Also, method 400 includes determining an available calendar date and time for a scheduling event, in response to a scheduling request, based on availability in the user calendar and availability in each of the a plurality of calendars, each corresponding to a calendar connection, as shown in block 445. Upon finding availability, the event is scheduled on the user calendar and each of the plurality of calendars as well as a notification of the scheduled event is sent to the user and each calendar connection.

Persons of ordinary skill in the art understand that embodiments of method 400 may include a subset of the steps shown and described in FIG. 4 as well as the order of the steps may be rearranged. Further, additional steps may be implemented by the method 400 before, after, and in between the steps shown and described in FIG. 4. In addition, the steps of method 400 may be implemented by one or more modules executed by one or more calendar computing devices as described herein.

Referring to FIG. 1, in another embodiment, a student at a college, university, or other educational institution may use one or more user computing devices (110-114) to schedule courses using embodiments of a calendar application as described herein. The student may enter user information such as a user profile including a major and minor (e.g., field) of study as well as user configuration information including user schedule preferences and user schedule constraints. Such user information may be provided to a calendar cloud computer server 106.

In addition, an educational institution computer server 102 may provide course requirements for a field of study and other information to the calendar cloud computer server 106. Moreover, an instructor or professor of a course may use an instructor computing device 104 to enter and provide course information, for specific courses, such as class times, exam times, syllabus of assignments, etc. The cloud calendar computer server 106 determines a course schedule for a student based on the user information, information provided by the educational institution computer server 102, and course information provided by the instructor computing device.

A calendar application may be downloaded onto a user computing device (110, 112, 114) by a student. Such a calendar application includes a user interface and may interact with a calendar cloud computer server 106 as described herein. Further, the calendar application or an embodiment thereof may also be downloaded to a professor's computing device 104 such that the professor may provide course calendar information as described herein.

Embodiments of the present disclosure provides several advantages over the current state of the art that include a student generating a course schedule based on a course requirements of a field of study as well as schedule constraints and schedule preferences using a calendar application over a communication network. Further, embodiments of the calendar application access course information from educational institution computer servers as well as instructor computing devices over a communication network, thereby integrating course information collection with course enrollment and scheduling using a calendar application. In addition, embodiments of the calendar application include integrating social media connections into the course scheduling aspects of the calendar application. This allows the calendar application to determining the student's social media connections that are currently enrolled in students courses as well as analyzing social media feedback on courses in generating a student's course schedule.

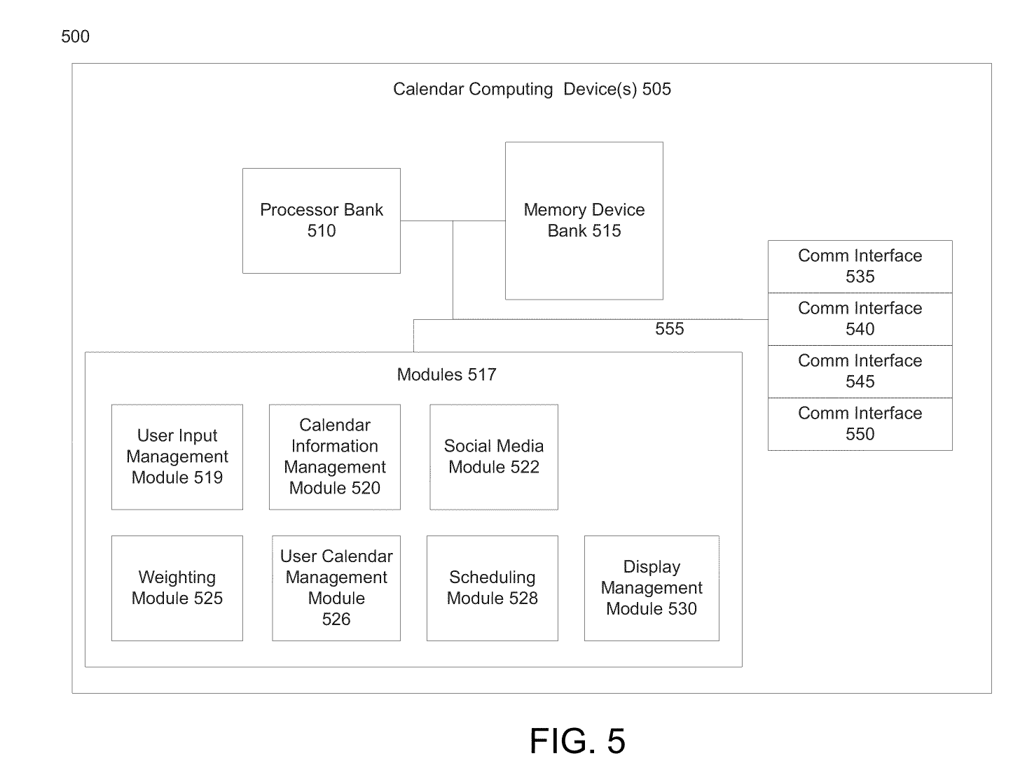

FIG. 5 is a block diagram 500 of a calendar computer device(s) 505 for planning a course schedule based on the course requirements of a field of study as well as based on the student's schedule constraints, preferences, and social media connections, in accordance with some embodiments. Such calendar computing device(s) 505 may include all or some of the computer server 102, computing device 104, calendar cloud computer server 106, and user devices (110, 112, 114) in the system 100 shown in FIG. 1. Further, the modules 517 may be located in all or spread among the different calendar computing devices in different embodiments. The calendar computing device(s) 505 may include several different components such as a processor bank 510, memory device bank 515, and one or more software applications, which may be executed by a processor. Thus, the combination of the software applications, as well as the processor and any other hardware, form specifically-configured modules 517 as described herein. Further, the modules 517 may be located in all or spread among the different calendar computing devices in different embodiments. Therefore, the specifically-configured modules 517 are specialized equipment that performs specialized functions. Further, the specifically-configured modules 517 transform the calendar computing device(s) 505 from a generic computing device that only performs generic functions to a specialized calendar computing devices that performs, inter alia, specialized calendar functions as described herein.

In addition, the calendar computing device(s) 505 also has/have one or more communication interfaces (535-550). The processor bank 510 may include one or more processors that may be co-located with each other or may be located in one module or in different parts of a calendar computing device 505, or among a plurality of calendar computing devices 505. The memory device bank 515 may include one or more storage devices that may be co-located with each other or may be located in one module, in different parts of a calendar computing device 505 or among a plurality of calendar computing devices 505. Types of memory devices may include, but are not limited to, electronic memory, optical memory, and removable storage media. The one or more modules 517 may include a user input management module 519, a calendar information management module 520, a social media module 522, a subscription module 524, a weighting module 525, a user calendar management module 526, a scheduling module 528, a display module 530. The modules 517 may be implemented by the one or more processors in the processor bank 510. A person of ordinary skill in the art would understand that the calendar application may be implemented by one or more modules described herein as well any other additional modules such that a person of ordinary sill in the art may call some embodiments of the calendar application a “calendar application platform.” Further, the modules and functions thereof may be combined or separated. In addition, such modules can be separated and portions thereof may be implemented across many devices or combined into one device.

The user input management module 519 manages the user input received from a user computing device. Such user input may be entered by a student on a user computing device through the user interface of a calendar application running on the user computing device. Such user input may include a schedule request for several courses to be incorporated into a course schedule for the student. The schedule request comprises user information that includes a user profile and configuration information such as, but not limited to, user schedule constraints, user schedule preferences, and other user configuration input (course preferences, course aversions, etc.).

A schedule constraint may be a factor in restricting scheduling of certain courses in a student's course schedule. For example, a student may be on a sport scholarship. Such student may have practice for the sport from 7 am to 9 am every weekday morning. Thus, a schedule constraint is that the student must attend practice and cannot attend any courses during these times. However, a schedule preference is a factor in planning a course schedule, if possible, but not restriction. For example, a student may prefer not to attend classes at 8 am each weekday morning because the student is not an early morning riser but has not conflict in their schedule that would restrict attending a course at that time. User schedule constraints include but are not limited to, time of day constraints, geographic constraints, instructor constraints, and exam schedule constraints. User schedule preferences include time of day preferences, geographic preferences, instructor preferences, and exam schedule preferences.

In addition, the user input management module 519 receives a user profile from the user computing device. The user profile may include a field of study, age, year in school, and other biographic and demographic information regarding the student. The schedule request, including user information such as the user profile and user configuration information, are sent to the calendar information management module 520 for further processing.

The calendar information management module 520 receives the user information including the user profile from the user input module 519. Upon processing the user profile, the calendar information management module 520 determines the field of study for the student. Further, the calendar information management module 520 accesses and analyzes data provided by the college or university to determine the course requirements and elective courses for the field of study for the student. Such information may be stored in a database accessible by the calendar computing device 505 or stored in the memory device bank 515. Once the course requirements and elective courses are accessed and processed, the calendar information management module 520 may access the course calendar information for each of the course requirements and elective courses including class times, exam times, schedule of assignments, etc. Such course calendar information is provided by each instructor of the course and stored in a database accessible by the calendar computing device 505 or stored in the memory device bank 515. The calendar information management module 520 may send the course requirements, elective courses, and the respective course information to the scheduling module 520 for further processing.

Also, such calendar information, from the educational institution or instructor, may be stored in a database as a database data structure. Further, the calendar information management module may access such calendar information through an Application Programming Interface from an educational institution computer server 102 that is in one type of data structure and must convert or transform such calendar information into a database structure when storing in the database. Alternatively, a subset of the calendar information may be course information provided from an instructor's user computing device running an embodiment of the calendar application. Further, an instructor of a course may modify a course event (e.g., exam date). If so, the calendar information management module 520 may send such data to the scheduling module 528 to automatically notify an enrolled student as well as enter the modified course event in the personal calendars of the enrolled student. The calendar application may provide a user interface on an instructor's computing device that includes a course information template or a course calendar template as well as drop down menus, dialog boxes, links, click button, push buttons, or any other user interface mechanisms. Thus, the calendar application receives the course calendar information in some type of user interface data structure and it is provided to the calendar information management module 520.

In addition, the calendar information management module 520 may receive organization information from an organization computing device. For example, a bar or restaurant may enter business information into an organization information template on a user interface of the calendar application running on the organization computing device. Upon storing such calendar information into the database, the calendar information management module 220 may convert or transform the calendar information from a user interface data structure into a database data structure.

Further, the organization information may include events such as drink and food specials during certain times of day (e.g., “Happy Hour”). Further, the bar/restaurant may request that the calendar application provide students that complete final exams around the time of the event, and in classrooms located near the business, an advertisement promoting an event. For example, a bar/restaurant may request the calendar application to send an advertisement to students that complete exams at around 5 pm near the Psychology building because it is located within walking distance of the exam venue.

Such an advertisement is generated by calendar information management module 520 by searching/processing the course schedule of each student to determine which students have exams scheduled in the Psychology building that end around 5 pm. As described herein, the calendar information management module 520, generates an advertisement that is sent as a message (text, email, alert, notification) by the display management module 530. Therefore, the calendar information management module 520 converts or transforms calendar information from one or more students into an advertisement message for each student.

The social media module 522 may receive user information that includes instructions from the user input module 519 that allows a calendar computing device 505 to communicate with a social media server. This may include receiving login credentials for the student's social media account and accessing the student's social media account. The social media module 522 interacts with the student's one or more social media accounts to determine the student's social media connections and the associated enrolled courses for each social media connection. That is, when proposed courses are determined to be part of a student's course schedule, the social media module 522 analyzes the student's social media connections and determines the social media connections currently enrolled in the same courses as in the (proposed) course schedule. In addition, the social media module 522 analyzes the feedback provided by the student's social media connections who have completed the courses in the (proposed) course schedule. The social media connections and the course feedback from each social media connection are provided to the weighting module 525 and/or scheduling module 526 to finalize a (proposed) course schedule.

The weighting module 525 interacts with the calendar information management module 520, social media module 522, and the scheduling module 528 to assist in determining the course schedule for the student based on the user profile and user configuration information such as user schedule constraints and user schedule preferences. The calendar information management module 520 provides the weighting module 525 with the course requirements and elective courses for the student's field of study. Further, the user input module provides the weighting module 519 with the user schedule constraints and user preferences. In addition, the social media module 522 provides the weighting module 525 with the enrolled courses for each user social media connection as well as the feedback provided by the user social media connections of the course requirements and elective courses. Moreover, the weighting module 525 weighs the course requirements and/or elective courses based on user schedule constraints, user schedule preferences, and the social media feedback from user social media connections as well as possibly prioritizing prerequisites, course requirements, and electives over other courses. In addition, the weighting module 525 ranks the course requirements and the elective courses based on a weight of each of the courses. The rank of each course is provided to the scheduling module 526. The weighting module 525 may use algorithmic, heuristic, and/or iterative methods to weight and rank courses, embodiments of which are described herein.

The scheduling module 528 determines a (proposed) course schedule for the student based on the rank of each course of the course requirements and elective courses, as determined by the weighting module 525.

The user calendar management module 526 may generate a user calendar for the user, in response to a schedule request from the user device. The user calendar may include the student's (proposed) course schedule as described herein. Further, in some embodiments, the user calendar management module 526 may need to access the calendar information to be presented on the user calendar from a database. In such embodiments, the user calendar management module 526 may convert or transform the calendar information from a database data structure to a calendar database structure. Thus, a portion of the calendar information may have been converted from a user interface data structure into a database data structure and then from a data base data structure into a calendar data structure.

The display module 530 receives the course schedule for the student and provides the course schedule to the user computing device such that the course schedule is presented on calendar user interface of a calendar application implemented by the user computing device.

Each of the communication interfaces (535-550) may be software or hardware associated in communicating to other devices. The communication interfaces (535-550) may be of different types that include a user interface, USB, Ethernet, WiFi, wireless, optical, cellular, or any other communication interface coupled to a communication network.

An intra-device communication link 555 between the processor bank 510, memory device bank 515, modules 517, and communication interfaces (535-550) may be one of several types that include a bus or other communication mechanism.

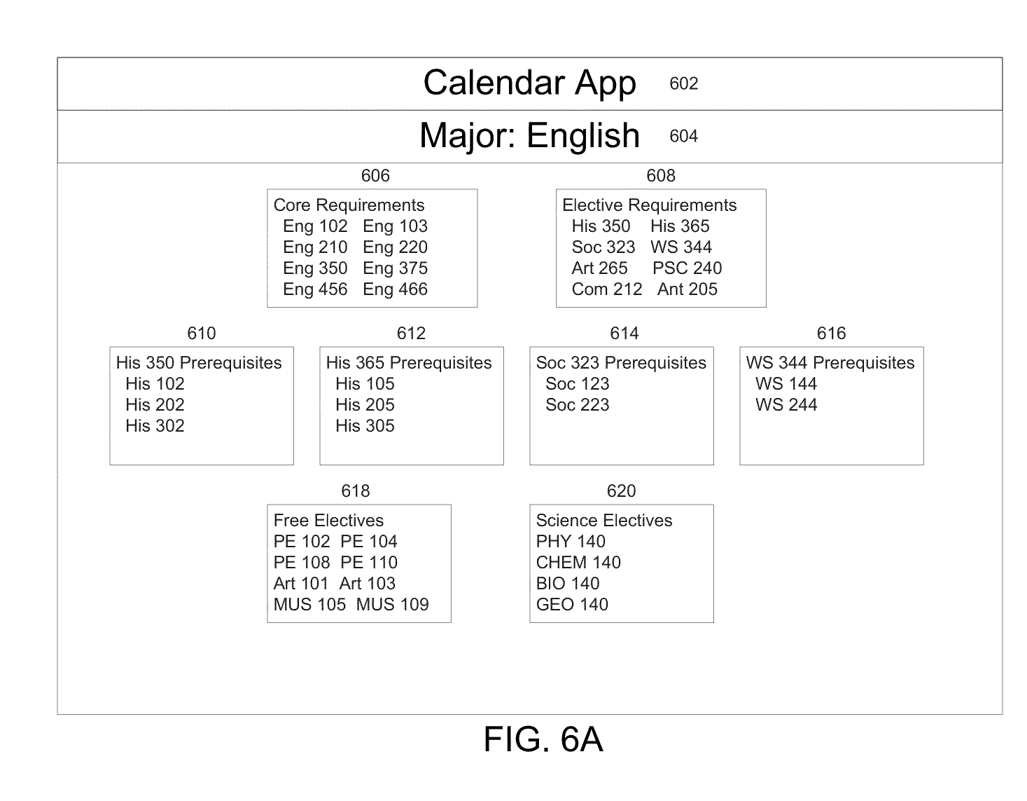

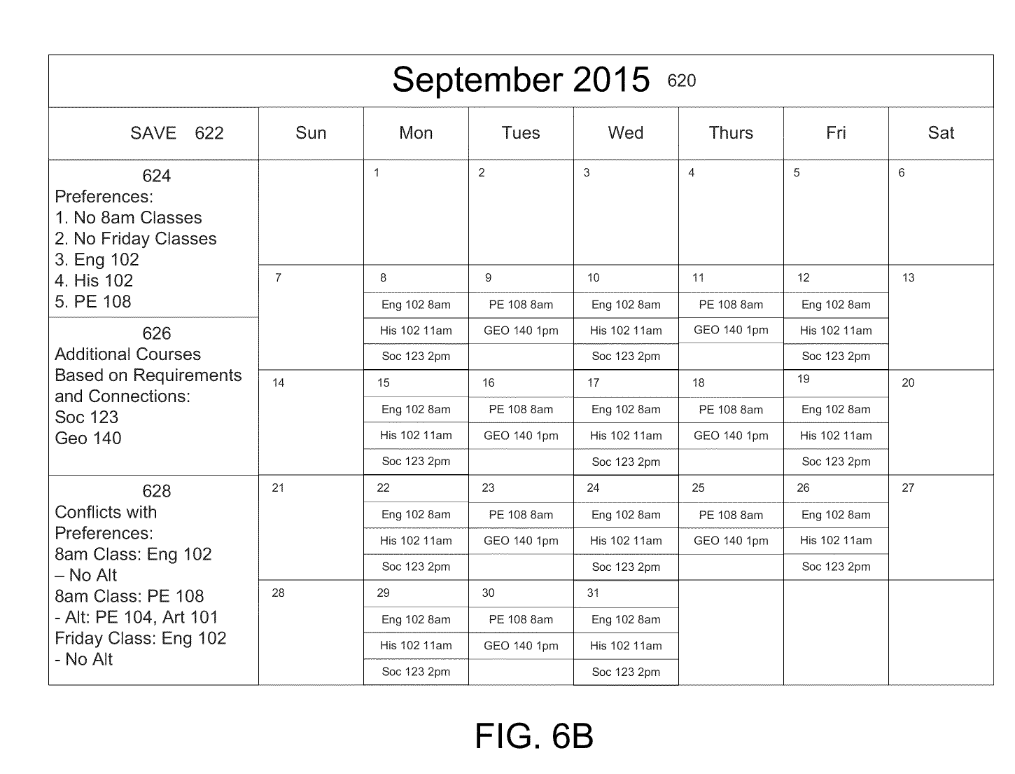

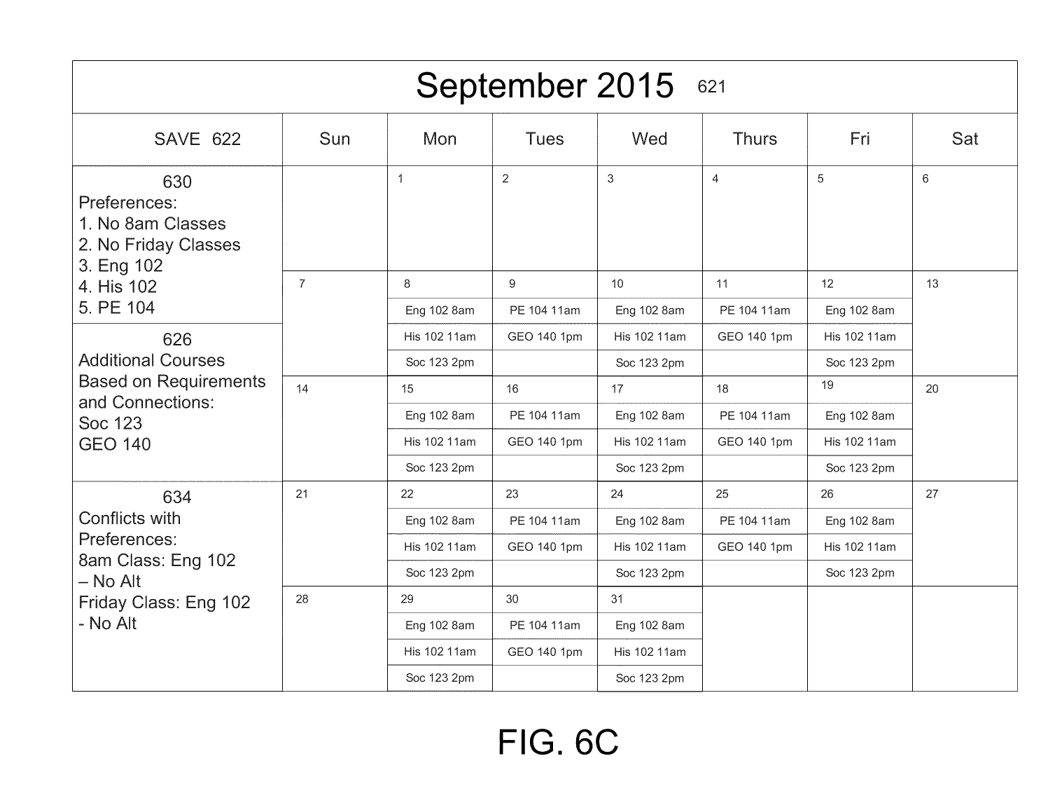

FIGS. 6A-6C are user interfaces for scheduling calendar information in accordance with some embodiments. In one embodiment, a student may enter a user profile that includes the student's major of study. For example, the student's major (or field) of study may be English. Upon entering a user profile using a calendar application on a user computing device, the user profile is sent to a calendar computer server. The calendar computer server may access an educational institution computer server to access the course requirements and elective courses (i.e., electives) for the major. Referring to FIG. 6A, such course requirements and elective courses may be displayed on a user interface of a calendar application 602 for a particular major 604. For example, for an English major, there may be course requirements that include eight core course requirements 606 such as English 102, English 103, English 210, English 220, English 350, English 375, English 456, and English 466. In addition, an English major may need further elective requirements 608 such as History 350, History 365, Sociology 323 Women Studies 344, Art 265, Political Science 240, Communications 212, and Anthropology 205. In some embodiments, an English major may only need to take a subset of these elective requirements. However, the student may need to complete a prerequisite course requirement prior to completing an elective requirement. Thus, the calendar application may display the prerequisite course requirements for each of the elective requirements. Thus, the History 350 prerequisite requirements 610 may be History 102, History 202, and History 302. Further, History 365 prerequisite requirements 612 may be History 105, History 205, and History 305. In addition, Sociology 323 prerequisite requirements 614 may be Sociology 123, and Sociology 223. Also, Women Studies 344 prerequisite requirements 616 may be Women Studies 144 and Women Studies 244. Moreover, the free electives 618 and science electives 620 are displayed on the calendar application 602 user interface. The student may be required only to take a subset of the free electives 618 or science electives 620. The free electives 618 may include Physical Education 102, Physical Education 104, Physical Education 108, Physical Education 110, Art 101, Art 103, Music 105, and Music 109. Science electives 620 may include Physics 140, Chemistry 140, Biology 140, and Geology 140.

Upon viewing the course requirements and electives, a student may input the student's schedule constraints, schedule preferences, and other configuration information to generate a course schedule. Schedule constraints are factors in scheduling that must be met due to university regulations, student's physical condition, financial assistance, etc. Schedule preferences are factors in scheduling that may be met due to a student's likes and aversions, if possible.

Schedule constraints may include time of day constraints, geographical constraints, instructor constraints, and exam schedule constraints. Time of day constraints, for example, may be that a student cannot attend 8 am class time due to participating in a work study program. Geographical constraints, for example, may be that a particular student can only have classes within a certain distance (e.g., 1 mile, 0.5 mile, 100 yards, etc.) of each other due to medical reasons or due to the lack of transit time in between classes. That is, a first class ending at 1 pm and a second class starting at 1:15 pm two miles away is a geographical constraint because the fastest the student can walk two miles is twenty minutes. An instructor constraint, for example, may be that the student must avoid an instructor due to a conflict of interest such as the instructor being a relative to the student. Exam schedule constraints, for example, may be that the university has a rule that the student cannot schedule three final exams in a twenty-four hour period.

Schedule preferences may include time of day preferences, geographical preferences, instructor preferences, and exam schedule preferences. Time of day preferences, for example, may be that a student does not like to attend 8 am class time due to being a late riser. Geographical preferences, for example, may be that a particular student would like to only have classes within a certain distance (e.g., 1 mile, 0.5 mile, 100 yards, etc.) so as to limit physical exertion to transit in between classes. That is, a student may prefer a first class ending at 1 pm and a second class starting at 1:15 pm if the classrooms for each class is only one hundred yards away as opposed to one mile away to limit the walking or physical exertion between classes. An instructor preference, for example, may be that the student would like to avoid an instructor due to the instructor having a reputation for being difficult with students. Exam schedule preference, for example, may be that a student would prefer an exam schedule every other day for ample time for studying between exams.

In addition, the student may provide, or the calendar application may be programmed, based on configuration information such as a student's social media connections and their feedback. For example, the calendar application may be configured such that each course for the student should have at least one social media connection enrolled. Alternatively, for a course with group projects, the calendar application may be configured such that the course should have at least three social media connections so as to form a study group.

Also, social media connections can provide feedback on a completed course based on a rating (e.g., 3 out of 4 rating) or some other feedback. If, for example, a rating is out of 4, the calendar application may be configured such that a student is enrolled in courses that are rated 3.0 or above.

Based on the student's course requirements, electives, schedule constraints and schedule preferences as well as other configuration information, the calendar application weighs and ranks each course. Further, the calendar application generates a student's (proposed) course schedule based on the rank of each course.

The weights and ranks may be determined by processes programmed and/or configured into the calendar application (and implemented by a weighting module). An example process to determine weights and ranks may be the following. A student may be required to complete core requirements 606 and elective requirements 608. Further, prerequisites may be completed for some of the elective requirements 608. Further, only two free electives 618 may be required to complete and only one science elective may be required to complete. Thus, a student is required to take 29 courses towards his/her field of study. Further, the student may have a requirement to take 40 courses over 8 semesters to graduate in his/her field of study. Thus, the student has 11 courses in which to take any course offered the university.

Based on the requirements of the field of study, weights for certain courses may be determined. For example, if a student has not taken History 350 or any of the prerequisites, History 102, History 202, and History 302, and is in enrolling in his/her fifth semester, then History 102 must be given a high weight so that the student can complete all the prerequisites to the elective requirement as well as the elective requirement itself upon completion of the student's eighth semester, thereby avoiding delay in the student's graduation. However, if the student is enrolling in his/her first semester, then History 102 is given a lower weight because the student has time prior to completion of his/her eight semester to complete all the prerequisites of the elective requirement and the elective requirement itself

Thus, in the example shown in FIG. 6A, a student may be enrolling in his/her first semester. She prefers to take English 102 and History 102 to complete one course requirement and a prerequisite for an elective requirement. Thus, the calendar application may weigh each course a high weight. Further, the student would prefer to enroll in a free elective, Physical Education 108. The calendar application may weigh this course high as well. Upon designating initial weights and parameters, the calendar application performs a search of available class times for the preferred courses.

Referring to FIG. 6B, a course schedule on a calendar is generated on the user interface of the calendar application based on course requirements, user schedule constraints, user schedule preferences, and user social media connections. The proposed course schedule for September 620 is shown and lists class meeting times for several different courses. Further, the user interface lists the user schedule preferences 624, courses selected based on course requirements and social media connections 626, and conflicts with preferences 628. Thus, the September course schedule 620 lists English 102 at 8 am, History 102 at 11 am, and Sociology 123 at 2 pm on Mondays, Wednesdays, and Fridays. Further, the September course schedule 620 lists Physical Education 108 at 8 am and Geology 140 at 1 pm on Tuesdays and Thursdays. The user schedule preferences 624 are listed as No 8 am class times, No Friday classes, English 102, History 102, and Physical Education 108. Further, Sociology 123 and Geology 140 were proposed and incorporated into the course schedule due to additional course requirements and social media connections 626 (i.e., social media connections currently enrolled courses, feedback from social medication connections that were already completed. That is, the student listed that he/she would prefer to enroll in three classes: English 102, History 102, and Physical Education 108. However, the calendar application determined, upon processing the student's field of study, that the student must enroll in two more courses to complete the course requirements on time (e.g., four years, eight semesters, etc.). Thus, the calendar application may have to select two courses from a set of course requirements. Further, the calendar application may use either the number of social media connections enrolled in each course and/or the feedback of social media connections as factors for course selection in its weighting and ranking of courses for the student's course schedule. In the example shown in FIG. 6B, the calendar application determined that Sociology 123 and Geology 140 were the best courses in which to enroll the student.

Further, conflicts 628 are listed as English 102 conflicts with the user schedule preference of no 8 am class. Unfortunately, there is no alternative class time for the course. In addition, English 102 also conflicts with the preference of no Friday class time. Also, no alternative class time is available. That is, English 102 is a required course for the student in his/her field of study. Further, English 102 may be a prerequisite for other course requirements. Thus, the calendar application may weigh/rank English 102 very high such that it overrides any schedule preferences.

Moreover, Physical Education 108 conflicts with the no 8 am user schedule preference. However, alternative courses exist that have class times that meet the course requirements as well as user schedule preferences including Physical Education 104 and Art 101. This may be the case because Physical Education 108 is not a strict course requirement but is one of several different courses the student may take to complete his/her field of study. Hence, due to the student's schedule preference of no 8 am classes, the calendar application may list Physical Education 104 and Art 101 as alternatives to Physical Education 108. Upon reviewing the course schedule, student may save the course schedule using a push button 622 or provide user input to modify the course schedule 620 (e.g., provide additional schedule preferences, constraints, or other configuration input).

Referring to FIG. 6C, a modified September course schedule 621 is shown. The course schedule 621 is different in one aspect when compared to the (proposed) course schedule 620 listed in FIG. 6B. That is, instead of listing Physical Education 108 at 8 am on Tuesdays and Thursday in the course schedule 620, the modified course schedule 621 lists Physical Education 104 at 11 am on Tuesdays and Thursdays. The list of schedule preferences 630 shows that Physical Education 104 is preferred over Physical Education 108. Additional courses remains the same as in FIG. 6B. The conflicts have been reduced as Physical Education 108 at 8 am on Tuesdays and Thursdays is no longer a conflict. Upon reviewing the course schedule, student may save the course schedule using a push button 622

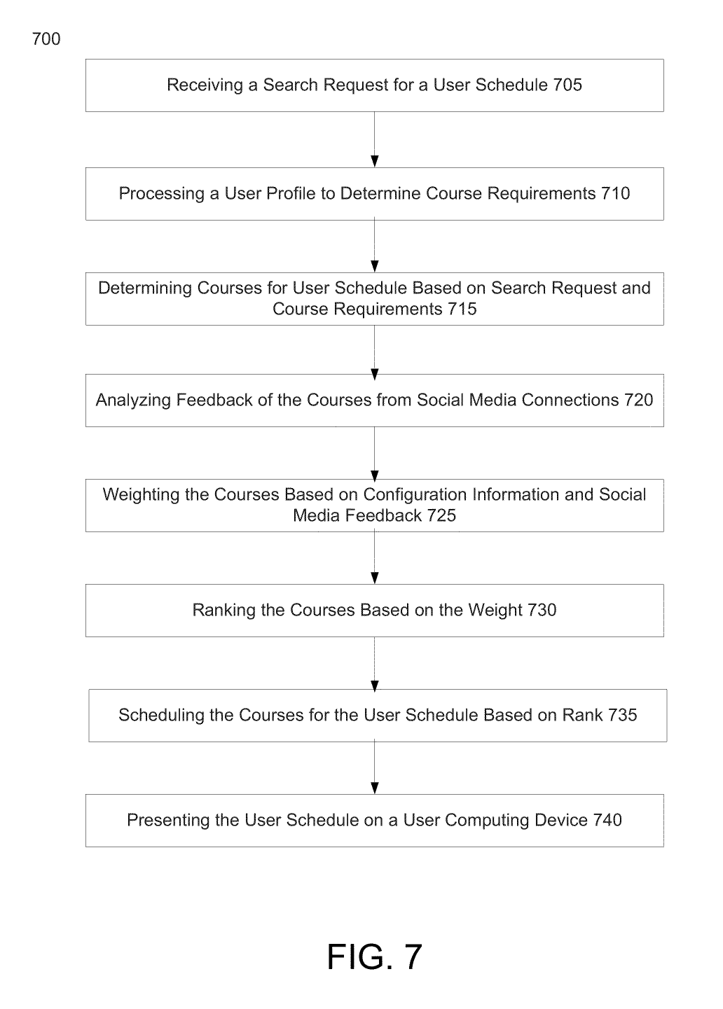

FIG. 7 is a flowchart of a method 700 for scheduling calendar information in accordance with some embodiments. The method 700 includes receiving, by a calendar server, a schedule request for a plurality of courses (e.g., proposed course schedule) from a user computing device for a student such that the schedule request includes user information, as shown in block 705. User information may include a user profile as well as user configuration information such as schedule constraints, schedule preferences, and other configuration information. Further, method 700 includes processing a user profile to determine course requirements for a user, as shown in block 710. That is, a user profile may include a student's field of study and the calendar application determines course requirements based on such a field of study. In addition, method 700 includes determining the plurality of courses based on the schedule request and course requirements, as shown in block 715. Moreover, method 700 includes analyzing social media feedback of the plurality of courses from social media user connections, as shown in block 720. Also, method 700 includes weighting the plurality of courses based on configuration information as well as social media connections and feedback from the social media connections, as shown in block 725. Further, method 700 includes ranking the plurality of courses based on the weight of each of the plurality of courses, as shown in block 730. In addition, the method 700 includes scheduling the plurality of courses for the user schedule based on a rank of each of the plurality of courses, as shown in block 735. Also, the method 700 includes presenting the proposed course schedule on a user computing device, as shown in block 740. In some embodiments, conflicts between schedule constraints, schedule preferences, and other configuration information may also be presented.

Persons of ordinary skill in the art understand that embodiments of method 700 may include a subset of the steps shown and described in FIG. 7 as well as the order of the steps may be rearranged. Further, additional steps may be implemented by the method 700 before, after, and in between the steps shown and described in FIG. 7. In addition, the steps of method 700 may be implemented by one or more modules executed by one or more calendar computing devices as described herein.

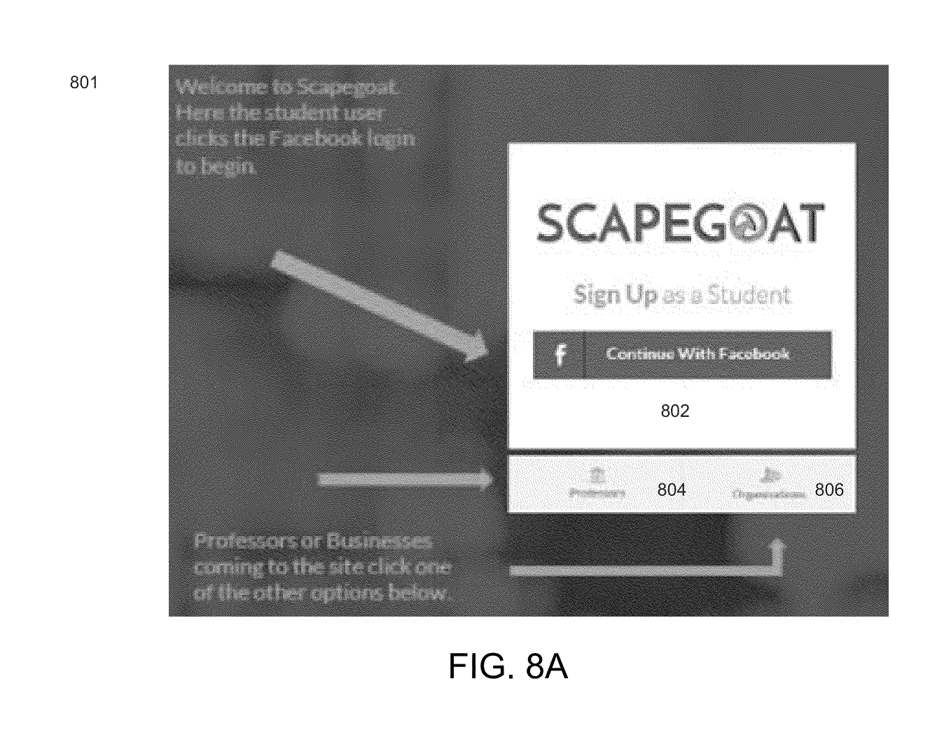

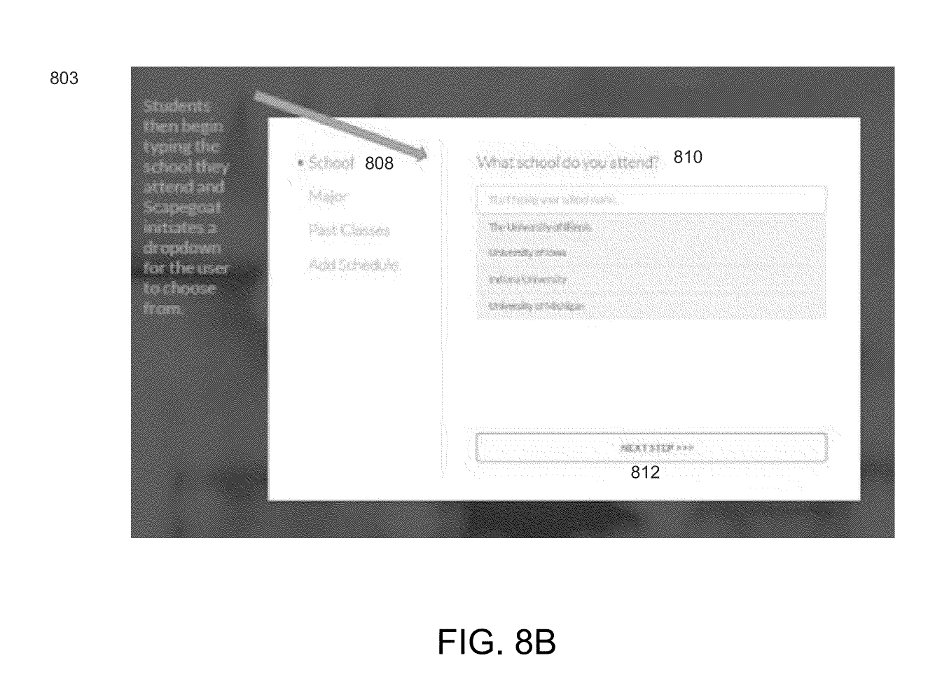

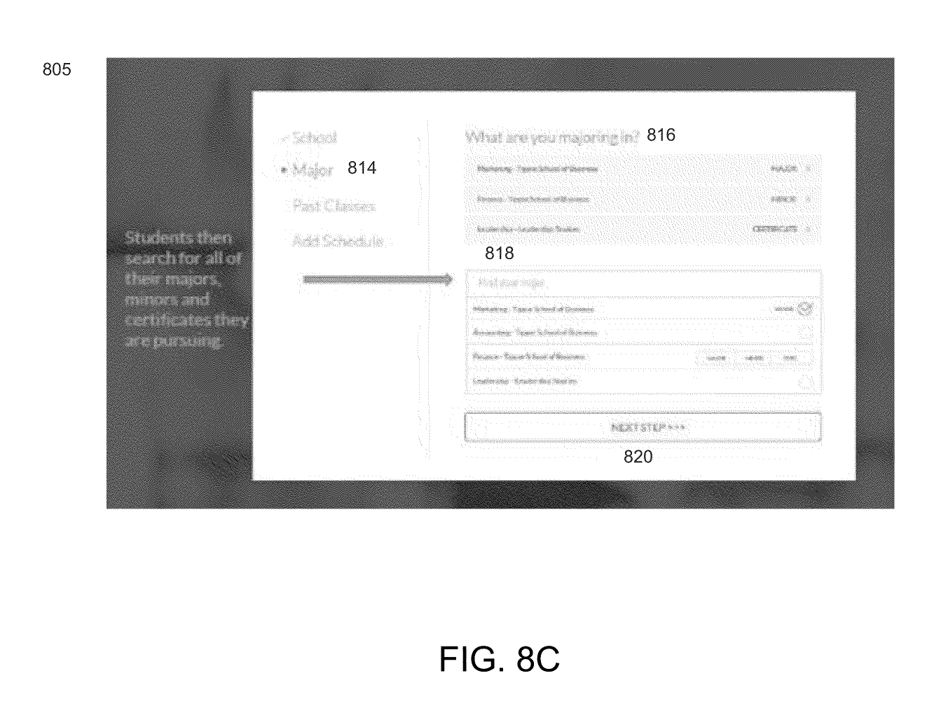

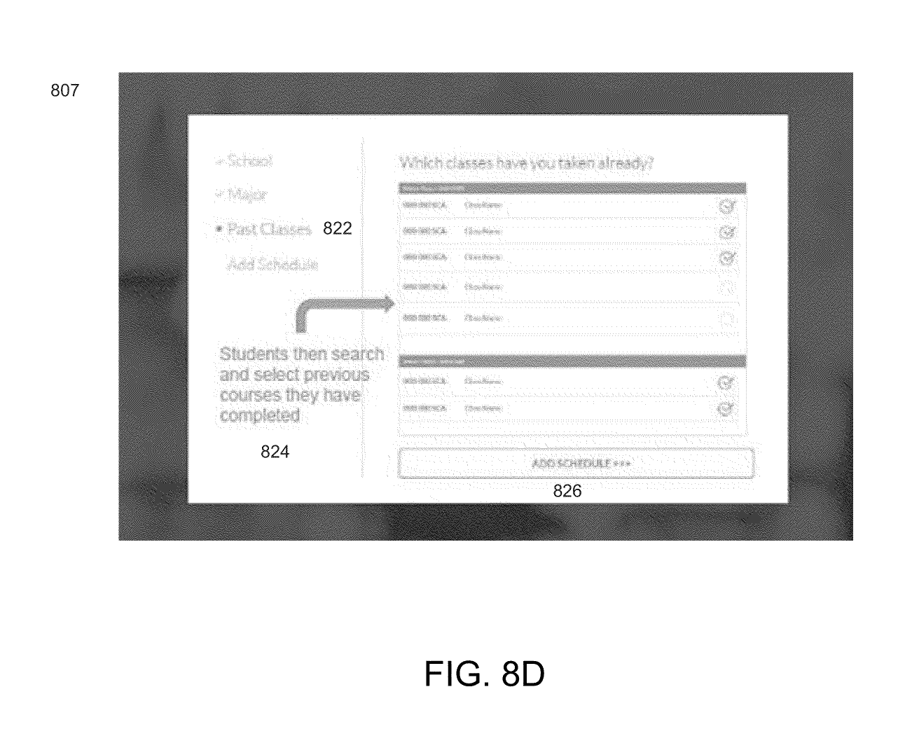

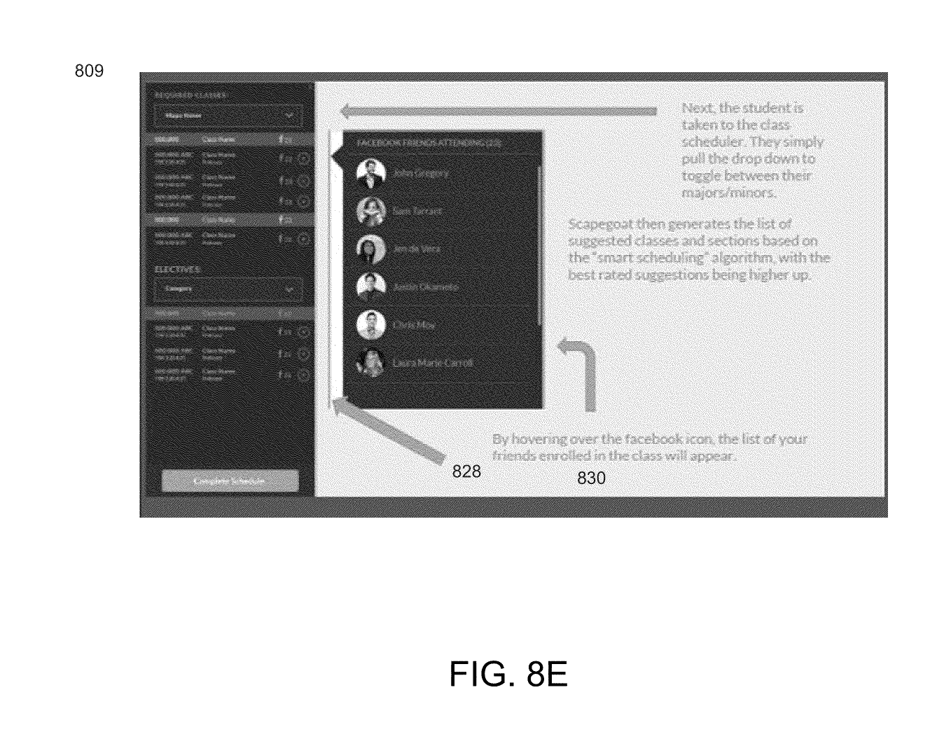

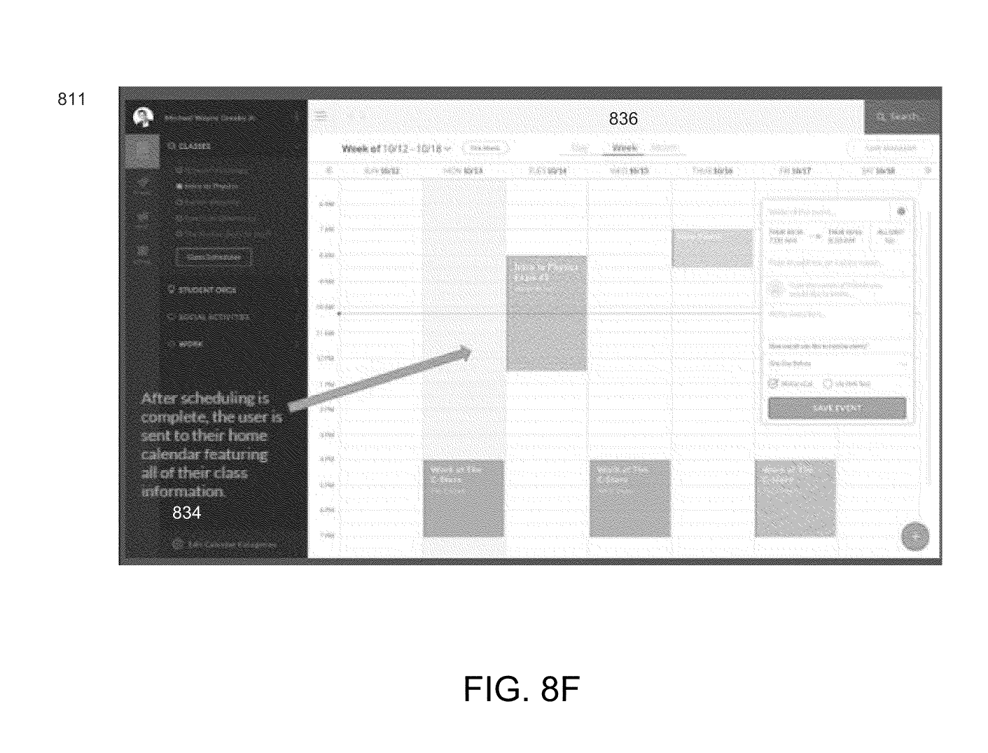

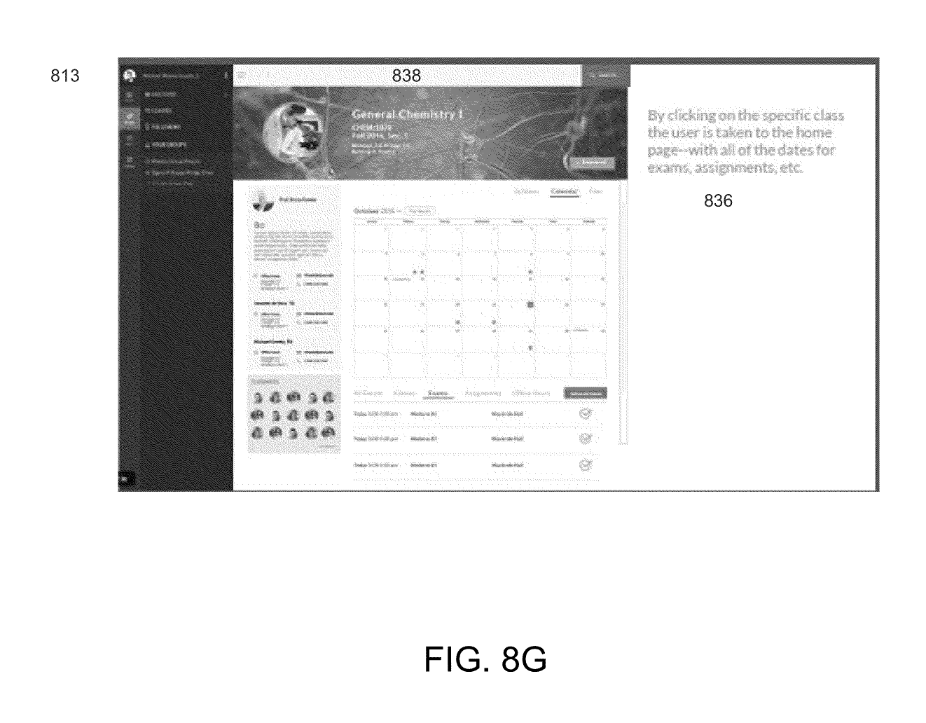

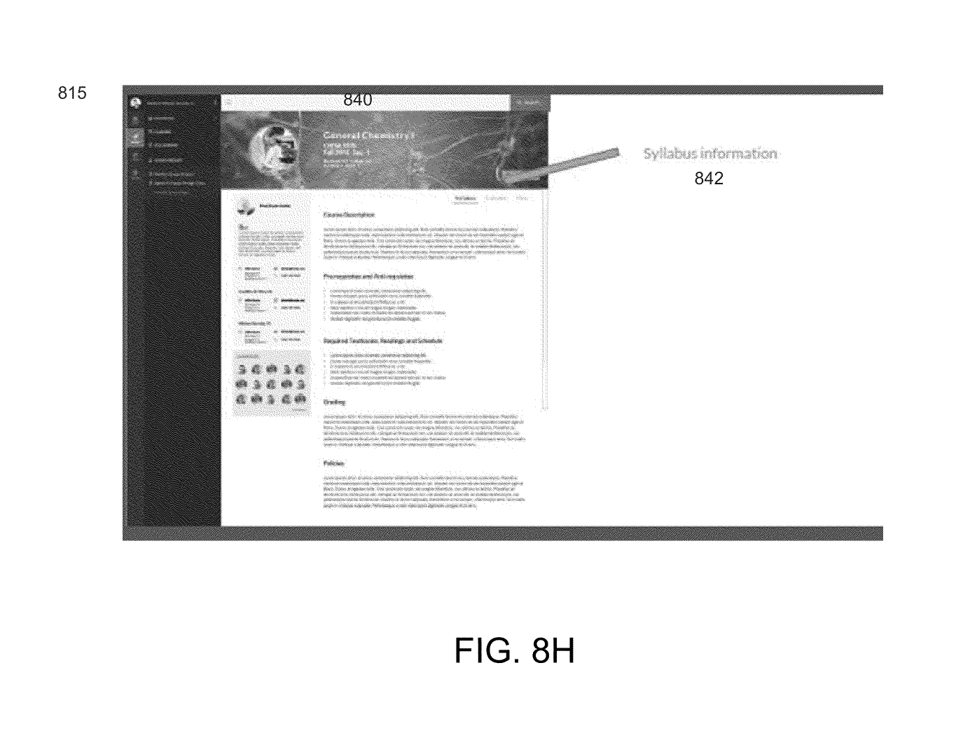

FIG. 8A-8H are user interfaces for scheduling calendar information by a student in accordance with some embodiments. Referring to FIG. 8A, a calendar application user interface is shown (i.e., Scapegoat). A student may log into the calendar application using social media (e.g., Facebook™) login credentials 802. Professors 804 and Businesses 806 can also login to provide course content or advertisements to students, respectively. Referring to FIG. 8B, upon logging into the calendar application, the student may enter or select (from a drop down menu) (808, 810) a university (or other educational institution) the student is attending. After a selection is made, the student may click on the push button, “Next Step” 812. Referring to FIG. 8C, a student may enter or select his/her major or minor (i.e., field) of study from a drop down menu (816, 818). After a selection is made, the student may click on the push button, “Next Step” 820. Referring to FIG. 8D, a student may enter past classes taken at the university 822. This may include searching and selecting courses he/she has completed by clicking respective course names on the user interface 824. After course/class selections are made, the student may click on the push button, “Add Schedule” 826.

Referring to FIG. 8E, the calendar application presents a class scheduler application to the user interface. This includes a listing of classes determined by the calendar application for the student based on the student's field of study 828. Note, in the present disclosure, the term “course” and “class” may be used interchangeably in certain circumstances. The courses/classes are determined by the weighing/ranking of a plurality of courses based on course requirements and electives for the student's field of study as well as configuration information such as schedule constraints and schedule preferences. Further, such a listing 828 may include the number of social media connections attending the class. By hovering an input device, such as a mouse pointer, over a social media icon next to a listed class, a list of social media connections 830 enrolled in the class is displayed.

Referring to FIG. 8F, upon completing a student's (proposed) course schedule, the user interface 834 displays the student's home or personal calendar listing the (proposed) course schedule in calendar form 836. That is, the calendar application may integrate the (proposed) course schedule with a student's personal calendar as well as any subscribed calendars as described herein. Referring to FIG. 8G, a student may click on a course in the home calendar and in response to the user interface displaying the course information 838 on the user interface that may include deadlines for exams, assignments, etc. 836. Referring to FIG. 8H, the student may click on a link on the course information page to display the course syllabus information 842 on the user interface.

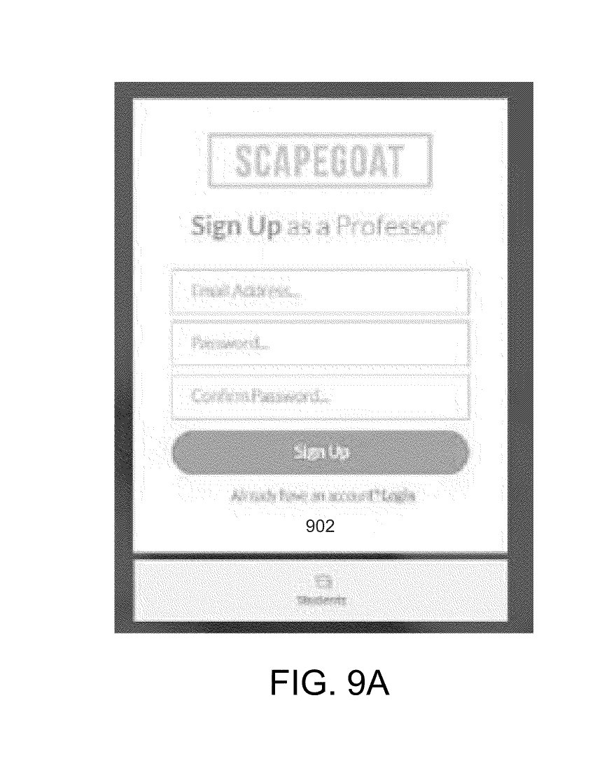

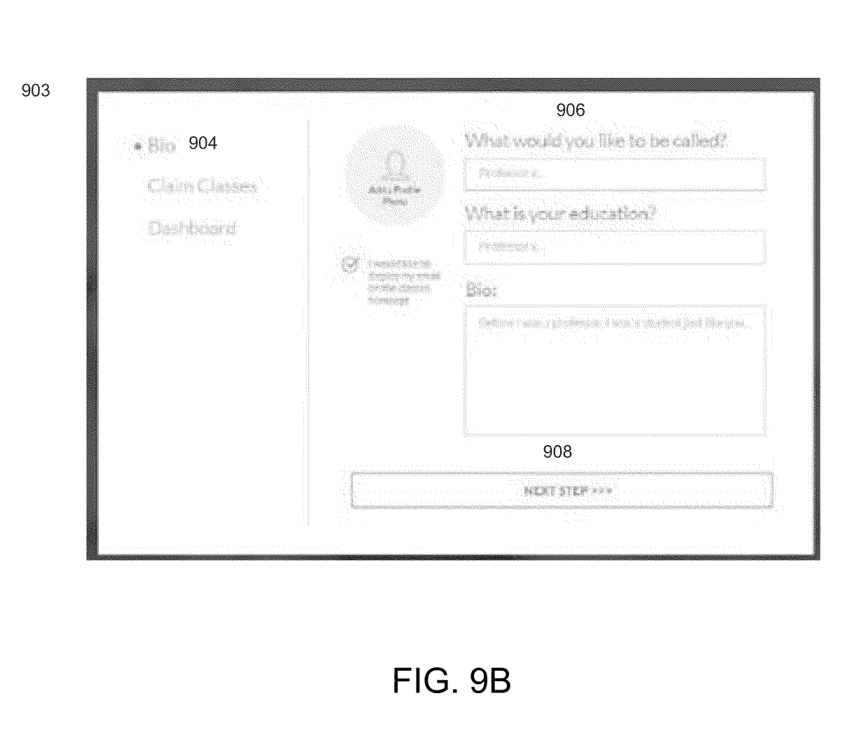

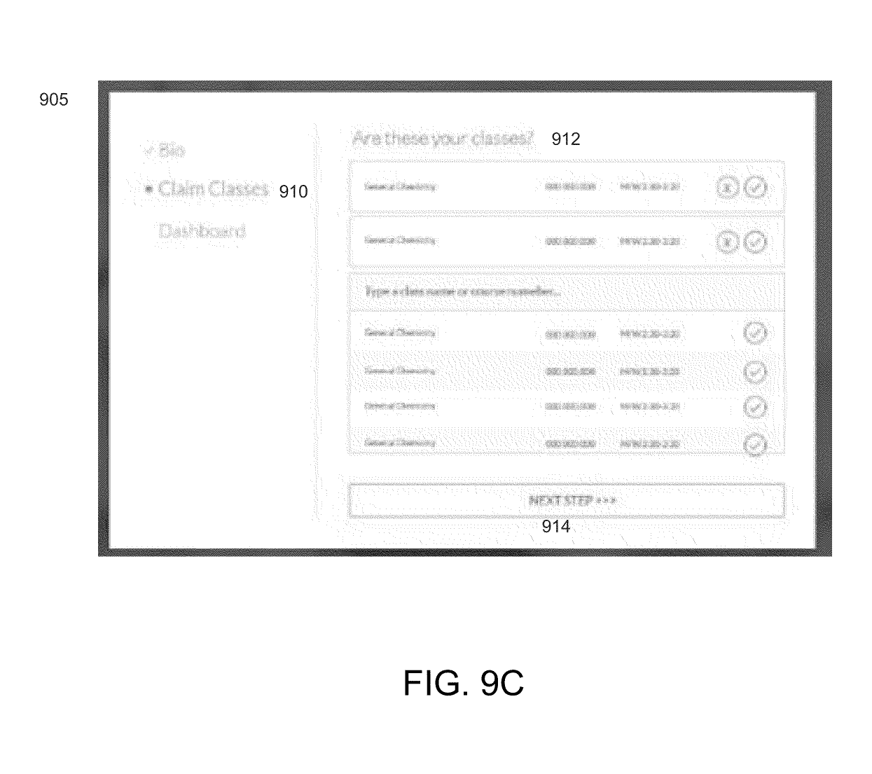

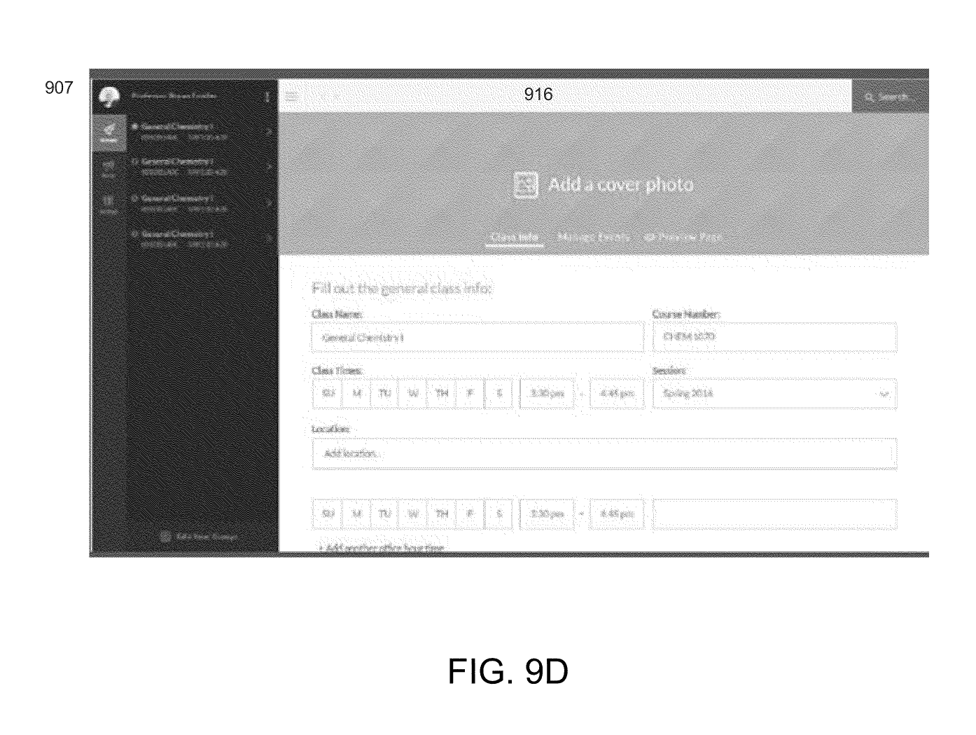

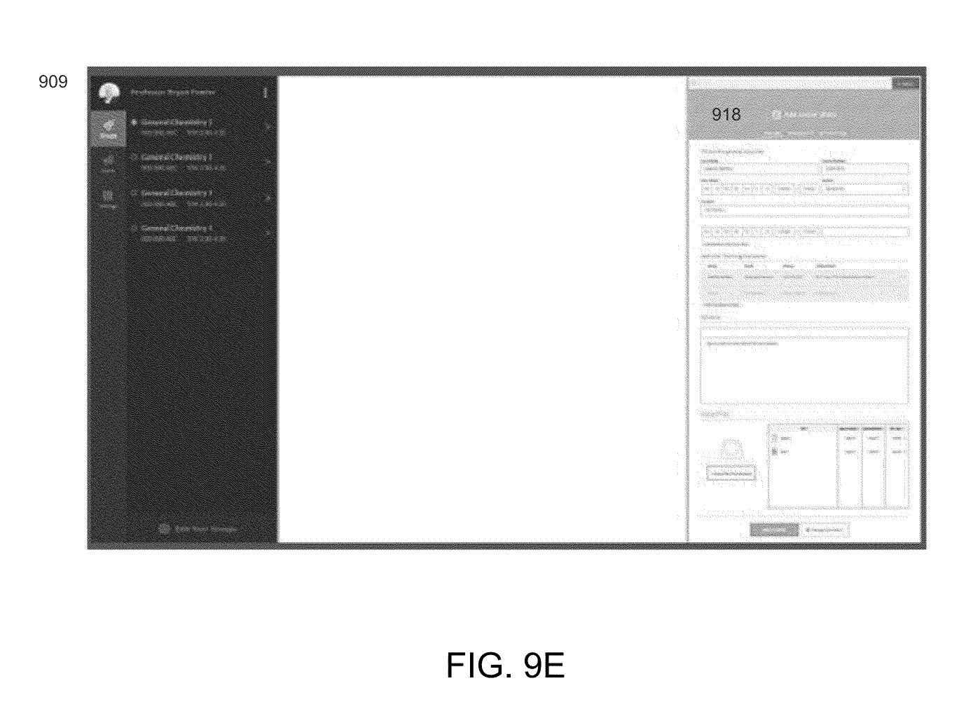

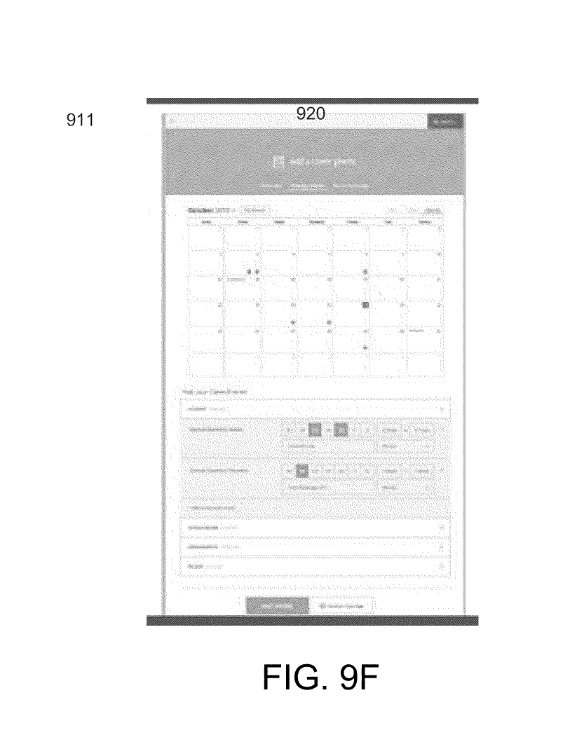

FIG. 9A-9F are user interfaces for scheduling calendar information by a professor in accordance with some embodiments. Referring to FIG. 9A, a professor can log into a calendar application using login credentials such as an email address and password 902. Referring to FIG. 9B, the calendar application displays on the user interface a biographical information template to allow the professor to enter biographical information such as his/her title, educational background and other biographical information. After entering such biographical information, the professor may click on the push button, “Next Step” 908. Referring to FIG. 9C, the user interface displays a list of classes that the professor may teach (910, 912). The professor can click on each class that he/she is or is not teaching, accordingly. After selecting such courses, the professor may click on the push button, “Next Step” 9914. Referring to FIG. 9D, the user interface displays a course information template and allows the professor to enter the course information 916 including general class information such as class time, location, etc. Referring to FIG. 9E, a different view of the course information 918 is displayed on the user interface. Referring to FIG. 9F, a user interface displays the class information in calendar form 920.

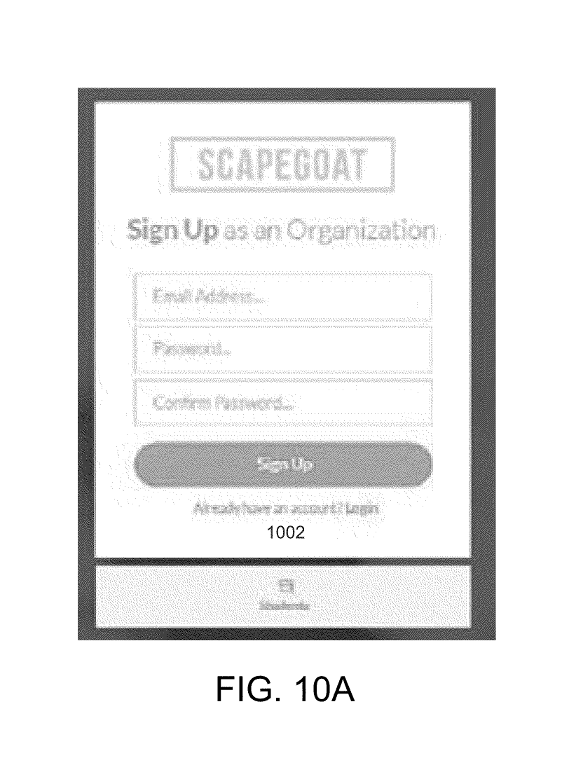

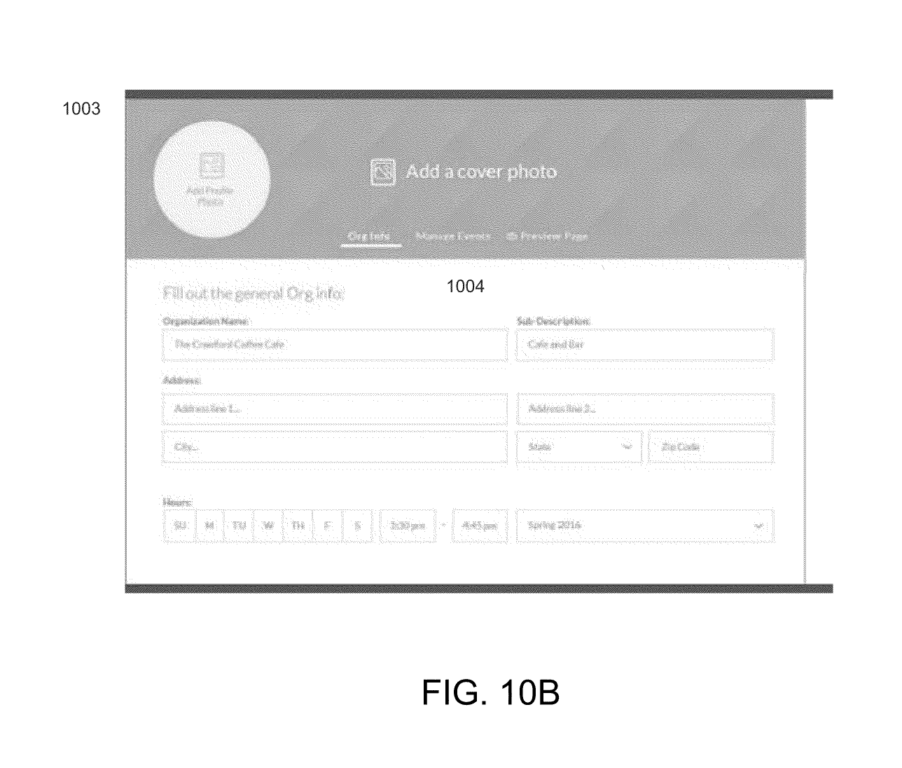

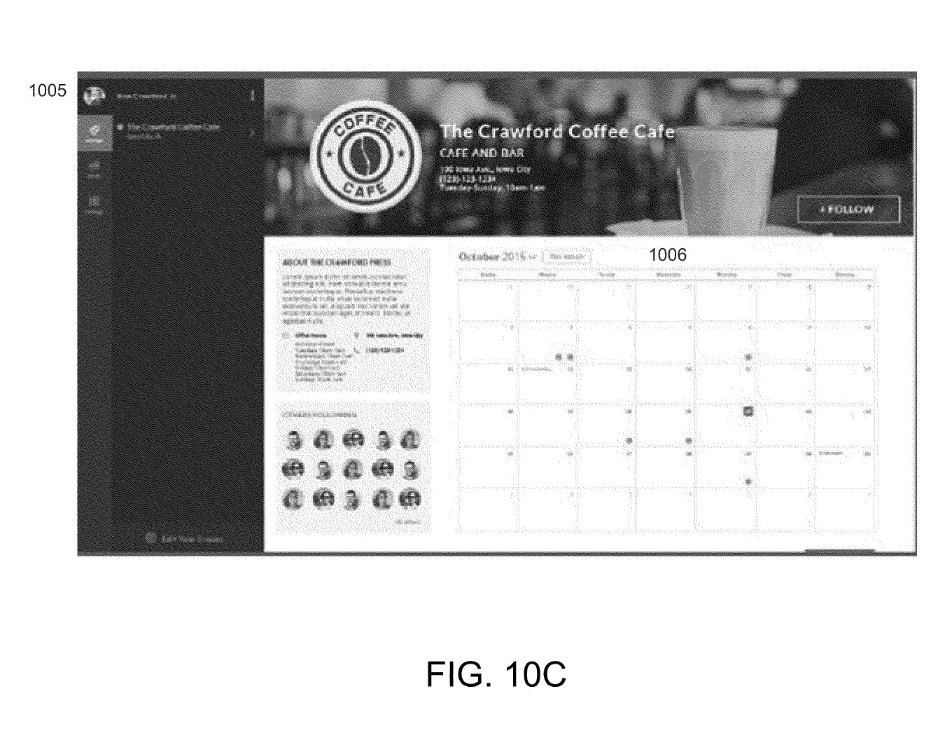

FIG. 10A-10C are user interfaces for providing organization information on students' calendar by an organization in accordance with some embodiments. Referring to FIG. 10A, organization personnel can log into a calendar application using login credentials such as an email address and password 1002. Referring to FIG. 10B, the organization personnel can enter general organization information such as name, address, description, hours of operation, etc. in the user interface 1004. Referring to FIG. 10C, an organization information page is shown 1006 that includes a calendar of events.

Businesses may analyze, or have a calendar service provider operating the calendar application analyze, course schedule information to provide incentives to students to purchases their goods and services. Such course schedule information may be provided or analyzed such that the businesses are not given a student's identity but only their course schedule. Other embodiments may have the calendar service provider analyze the students' course schedule information on behalf of the business. Thus, a business such as a bar/restaurant may provide configuration information to the calendar application to send an advertisement to any student having a final exam ending between 5 pm-8 pm to attend “Happy Hour” at the bar/restaurant after completing their final exam.

Persons of ordinary skill in the art would understand that embodiments of the present disclosure may be combined or separated. Further, persons of ordinary skill in the art would understand that steps in any methods or flowcharts described herein can be performed in any order.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
(a) storing, in a memory device by one or more calendar computing devices, a plurality of sets of calendar information from a plurality of calendars, each set of calendar information corresponding to a calendar provided by an associated calendar provider;
(b) causing to display a user calendar on a user device, by the one or more calendar computing devices, in response to a subscription request, a plurality of subscribed sets of calendar information, each set corresponding to a subscribed calendar.

2. The method of claim 1, further comprising receiving, by the one or more calendar computing devices, the plurality of sets of calendar information corresponding to a plurality of calendars from a plurality of calendar providers.

3. The method of claim 1, further comprising generating a user calendar for a user, by the one or more calendar computing devices, in response to a user generation request from the user device.

4. The method of claim 1, further comprising receiving, by the one or more calendar computing devices, a subscription request from the user device, wherein the subscription request includes a calendar identifier corresponding to one of the plurality of calendars wherein displayed calendar information corresponding to a subscribed calendar is based on the calendar identifier.

5. The method of claim 1, further comprising displaying, by the one or more calendar computing devices, a set of subscribed calendars on the user device.

6. The method of claim 1, further comprising providing, by the one or more calendar computing devices, in response to receipt of a sharing request, user calendar information from the user calendar to a plurality of calendar connections.

7. The method of claim 6, wherein providing the user calendar information is based on a sharing setting configurable by the user.

8. The method of claim 1, further comprising linking, by the one or more calendar computing devices, the user calendar to a plurality of calendars, each of the plurality of calendars corresponding to a calendar connection wherein the linking is in response to a linking request.

9. The method of claim 8, further comprising determining, by the one or more calendar computing devices, an available calendar date and time for a scheduling event, in response to a scheduling request, based on availability in the user calendar and availability in each of the plurality of calendars, each of the plurality of calendars corresponding to a calendar connection.

10. A method, comprising:
(a) receiving, by a calendar server, a schedule request for a plurality of courses from a user computing device for a user schedule wherein the schedule request includes configuration information;
(b) processing a user profile to determine course requirements for a user;
(c) determining the plurality of courses based on the schedule request and course requirements;
(d) analyzing social media feedback of the plurality of courses from social media user connections;
(e) weighting the plurality of courses based on configuration information and the social media feedback from user social media connections;
(f) ranking the plurality of courses based on a weight of each of the plurality of courses;
(g) scheduling the plurality of courses for the user schedule based on a rank of each of the plurality of courses;
(h) causing to present the user schedule on a user computing device.

11. The method of claim 10, further comprising interacting with the user's one or more social media accounts to determine the user social media connections.

12. The method of claim 10, further comprising:
(a) receiving configuration instructions from the user computing device for the user that allows a module executing on the calendar server to communicate with a social media server;
(b) receiving login credentials from the user computing device for the user's social media account;
(c) accessing the user's social media account.

13. The method of claim 10, wherein the configuration information includes at least one of:
(a) user schedule constraints;
(b) user schedule preferences;
(c) user configuration input.

14. The method of claim 10, wherein the rank is based on at least one of:
(a) a plurality of course requirements;
(b) a plurality of prerequisite course requirements;
(c) a schedule of each of the plurality of course requirements and the plurality of prerequisite course requirements.

15. The method of claim 13, wherein the user schedule constraints include time of day constraints, geographical constraints, instructor constraints, and exam schedule constraints.

16. The method of claim 13, wherein the user schedule preferences include time of day preferences, geographical preferences, instructor preferences, and exam schedule preferences.
